(19) United States
(12) Patent Application Publication
(10) Pub. No.: US 2003/0130772 A1
(43) Pub. Date: Jul. 10, 2003

(54) Electric vehicle drive control device, electric vehicle drive control method and program thereof

(75) Inventors: Masayoshi Yanagida, Anjo-shi (JP); Hiromichi Agata, Anjo-shi (JP); Toshio Okoshi, Anjo-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/327,093

(22) Filed: Dec. 24, 2002

(30) Foreign Application Priority Data
Dec. 26, 2001 (JP) 2001-394958

(51) Int. Cl. G06F 17/00; B60K 6/00

(52) U.S. Cl. 701/22; 180/65.1

(57) ABSTRACT

An electric vehicle drive control device includes an electric machine drive portion equipped with a first electric machine connected to a wheel of an electric vehicle and a second electric machine for running the electric vehicle and a controller that judges whether a stall determination condition which indicates whether the electric vehicle is in a stalled state is established, limits, if the stall determination conditions is established, an electric machine target torque of the second electric machine and compensates with an electric machine target torque of the first electric machine according to an amount of the electric machine target torque of the second electric machine that was limited, drives the first electric machine based on the compensated electric machine target torque of the first electric machine and drives the second electric machine based on the limited electric machine target torque of the second electric machine.

The disclosure of Japanese Patent Application No. 2001-394958 filed Dec. 26, 2001 including the specification, drawings and claims is incorporated herein by reference in its entirety.

### BACKGROUND OF THE INVENTION

1. Field of Invention

The invention relates to an electric vehicle drive control device, and an electric vehicle drive control method and program thereof.

2. Description of Related Art

A vehicle drive device is mounted in an electric automobile, which is an electric vehicle, which is designed to generate torque from the drive motor, which is an electric machine, i.e. drive motor torque, and transmit that drive motor torque to a drive wheel. The drive motor is designed so that at the time of powering (driving), it is driven by a direct current received from a battery and generates drive motor torque. At the time of regeneration (electric power generation), the drive motor receives torque due to inertia of the electric automobile, generates a direct current and supplies that electric current to the battery.

In addition, a vehicle drive device is mounted in a hybrid vehicle, which is an electric vehicle, which is designed to transmit engine torque, that is, a portion of which is transmitted to a generator (generator motor) and the rest is transmitted to a drive wheel. The drive device has a planetary gear unit equipped with a sun gear, a ring gear, and a carrier wherein the carrier is connected with the engine, the ring gear and drive motor are connected with the drive wheel, and the sun gear is connected with the generator, thereby generating driving force by transmitting to the drive wheel rotation that is output from the ring gear and the drive motor.

In each of the aforementioned vehicle drive devices, an inverter is provided between the drive motor and a drive motor control device. The inverter is designed to drive in accordance with a drive signal sent from the drive motor control device, receive a direct current from the battery, generate U, V, and W phase electric currents, and supply each electric current to the drive motor. Therefore, the inverter is equipped with multiple, for example, six transistors as switching elements, and each transistor is paired with each other forming a unit to constitute a transistor module (IGBT) for each phase. Accordingly, the transistors are turned on and off, and generate each phase electric current when a drive signal is sent to each transistor in a predetermined pattern.

The rotational speed of the drive motor, i.e. drive motor rotational speed, is detected by a drive motor rotational speed sensor, and control such as torque control of the drive motor, for example, is performed based on the drive motor rotational speed.

However, while the drive motor is driven to make the electric vehicle run, if the wheels of the electric vehicle are caught in a groove or run over a curb, the electric vehicle is stopped, and even if the driver steps on the accelerator pedal, the electric vehicle is unable to move, becoming stalled. In this stalled state, since the drive motor continues to be driven at a high load, a large electric current continuously flows to a certain phase transistor module, causing the transistor module to overheat. As a result, not only is the life of the transistor module shortened, but abnormalities are generated in the drive motor, thereby shortening the life of the drive motor as well. Therefore, a fail-safe is provided by the protection function of the inverter, stopping the drive of the drive motor and executing a shut down.

However, in the conventional vehicle drive device, when shut down is executed, the drive motor cannot be activated afterwards until the predetermined conditions for return are established.

### SUMMARY OF THE INVENTION

The invention thus provides an electric vehicle drive control device, and an electric vehicle drive control method and program that do not generate abnormalities in the electric machine, shorten the life of the electric machine, or execute shut down.

To this end, the electric vehicle drive control device according to a first exemplary aspect of the invention includes an electric machine drive portion equipped with a first electric machine connected to a wheel of an electric vehicle and a second electric machine for running the electric vehicle and a controller that judges whether a stall determination condition which indicates whether the electric vehicle is in a stalled state is established, limits, if the stall determination conditions is established, an electric machine target torque of the second electric machine and compensates with an electric machine target torque of the first electric machine according to an amount of the electric machine target torque of the second electric machine that was limited, drives the first electric machine based on the compensated electric machine target torque of the first electric machine and drives the second electric machine based on the limited electric machine target torque of the second electric machine.

In this case, according to the electric machine target torque of the first electric machine being limited, the electric machine target torque of the second electric machine is compensated. Also, a limited electric machine target torques of a second electric machine does not have to be the same as a compensated electric machine target torque of a first electric machine.

In addition, when the electric vehicle is stalled, the electric machine target torque is limited so that the second electric machine does not continue driving at a high load, therefore a large electric current does not continuously flow into a phase transistor module of an inverter, allowing prevention of transistor module overheating. Accordingly, not only can the generation of abnormalities in the second electric machine be prevented, but the life of the transistor module as well as the inverter and the electric machine is also lengthened.

Also, a fail-safe is not implemented by the protection function of the inverter, thus avoiding a shut down of the second electric machine, and allowing the second electric machine to continuously drive.

In an electric vehicle drive control method according to a second exemplary aspect of the invention, the method includes the steps of judging whether a stall determination condition that indicates whether an electric vehicle is in a stalled state is established, limiting, if the stall determination conditions is established, an electric machine target torque of a second electric machine for running the electric vehicle, and compensating with an electric machine target torque of a first electric machine connected to a wheel of the electric vehicle according to an amount of the electric machine target torque of the second electric machine that was limited, driving the first electric machine based on the compensated electric machine target torque of the first electric machine and driving the second electric machine based on the limited electric machine target torque of the second electric machine.

In a computer readable memory of an electric vehicle drive control device according to a third exemplary aspect of the invention, the computer readable memory includes a program that judges whether a stall determination condition which indicates whether an electric vehicle is in a stalled state is established, a program that, if the stall determination condition is established, limits an electric machine target torque of a second electric machine for running the electric vehicle, and compensates with an electric machine target torque of a first electric machine connected to a wheel of the electric vehicle according to an amount of the electric machine target torque of the second electric machine that was limited, a program that drives the first electric machine based on the compensated electric machine target torque of the first electric machine and a program that drives the second electric machine based on the limited electric machine target torque of the second electric machine.

For the purposes of this disclosure, device and means may be considered synonyms. Both relate to a computer and its programs and encompass any necessary memory. The device may be implemented solely by circuitry, i.e. hardware, or a combination of hardware and software. Further, in some cases, as defined in the specification, the device/means may include other elements.

### BRIEF DESCRIPTION OF THE DRAWINGS

Various embodiments of the invention will be described with reference to the following figures, wherein:

FIG. 1 is a function block diagram of an electric vehicle drive control device according to a first embodiment of the invention;

FIG. 2 is a conceptual diagram of a hybrid vehicle according to the first embodiment of the invention;

FIG. 3 is an operation explanatory drawing of a planetary gear unit according to the first embodiment of the invention;

FIG. 4 is a line drawing of vehicle speed during normal running periods according to the first embodiment of the invention;

FIG. 5 is a line drawing of torque during normal running periods according to the first embodiment of the invention;

FIG. 6 is a conceptual diagram of a hybrid vehicle drive control device according to the first embodiment of the invention;

FIG. 7 is a first main flow chart illustrating the operation of the hybrid vehicle drive control device according to the first embodiment of the invention;

FIG. 8 is a second main flow chart illustrating the operation of the hybrid vehicle drive control device according to the first embodiment of the invention;

FIG. 9 is a third main flow chart illustrating the operation of the hybrid vehicle drive control device according to the first embodiment of the invention;

FIG. 10 is a drawing illustrating a first vehicle requirement torque map according to the first embodiment of the invention;

FIG. 11 is a drawing illustrating a second vehicle requirement torque map according to the first embodiment of the invention;

FIG. 12 is a drawing illustrating an engine target operation state map according to the first embodiment of the invention;

FIG. 13 is a drawing illustrating an engine drive area map according to the first embodiment of the invention;

FIG. 14 is a drawing illustrating a subroutine of a sudden acceleration control process according to the first embodiment of the invention;

FIG. 15 is a drawing illustrating a subroutine of a drive motor control process according to the first embodiment of the invention;

FIG. 16 is a drawing illustrating a subroutine of a generator torque control process according to the first embodiment of the invention;

FIG. 17 is a drawing illustrating a subroutine of an engine start control process according to the first embodiment of the invention;

FIG. 18 is a drawing illustrating a subroutine of a generator rotational speed control process according to the first embodiment of the invention;

FIG. 19 is a drawing illustrating a subroutine of an engine stop control process according to the first embodiment of the invention;

FIG. 20 is a drawing illustrating a subroutine of a generator brake engage control process according to the first embodiment of the invention;

FIG. 21 is a drawing illustrating a subroutine of a generator brake release control process according to the first embodiment of the invention;

FIG. 22 is a drawing illustrating a subroutine of a stalled-state drive process according to the first embodiment of the invention;

FIG. 23 is a drawing illustrating a subroutine of a stall determination process according to the first embodiment of the invention;

FIG. 24 is a drawing illustrating a subroutine of a target torque limit process according to the first embodiment of the invention;

FIG. 25 is a drawing illustrating a first target torque limit map according to the first embodiment of the invention;

FIG. 26 is a time chart illustrating a stalled-state drive process operation according to the first embodiment of the invention;

FIG. 27 is a drawing illustrating a subroutine of a target torque limit process according to a second embodiment of the invention;

FIG. 28 is a drawing illustrating a second target torque limit map according to the second embodiment of the invention;

FIG. 29 is a drawing illustrating a subroutine of a stall determination process according to a third embodiment of the invention;

FIG. 30 is a time chart illustrating a stalled-state drive process operation according to the third embodiment of the invention; and

FIG. 31 is a drawing illustrating a subroutine of a stall determination process according to a fourth embodiment of the invention.

### DETAILED DESCRIPTION OF PREFERRED EMBODIMENTS

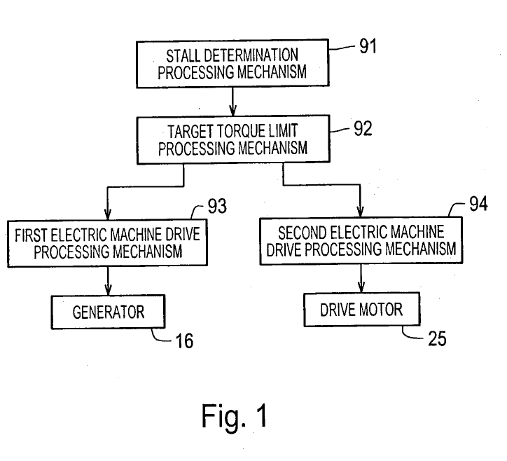

Hereafter, embodiments of the invention are described in detail with reference to the accompanying drawings. FIG. 1 is a function block diagram of an electric vehicle drive control device according to a first embodiment of the invention.

In the figure, reference numeral 16 denotes a generator corresponding to a first electric machine mechanically connected with drive wheels (not shown) which are wheels of an electric vehicle. Reference numeral 25 denotes a drive motor which corresponds to a second electric machine for driving the electric vehicle and is provided in an electric machine drive portion (not shown). Reference numeral 91 denotes a stall determination processing mechanism that determines whether stall determination conditions have been established that indicate that the electric vehicle is stalled. Reference numeral 92 denotes a controller that, when stall determination conditions are established, limits a drive motor target torque which is the electric machine target torque of a drive motor 25 and compensates a generator target torque which is the electric machine target torque of the generator 16 for only the amount of the drive motor target torque of the drive motor 25 that was limited. Reference numeral 93 denotes a first electric machine drive processing mechanism that drives the generator 16 based on the compensated generator target torque of the generator 16. Reference numeral 94 denotes a second electric machine drive processing mechanism that drives the drive motor 25 based on the limited drive motor target torque of the drive motor 25.

Next, the aforementioned hybrid vehicle will be described. As an electric vehicle, in place of a hybrid vehicle equipped with an engine, generator and drive motor, the invention is also applicable to electric vehicles having only a drive motor and not equipped with an engine or generator, as well as parallel hybrid vehicles having an engine and a drive motor, but not equipped with a generator.

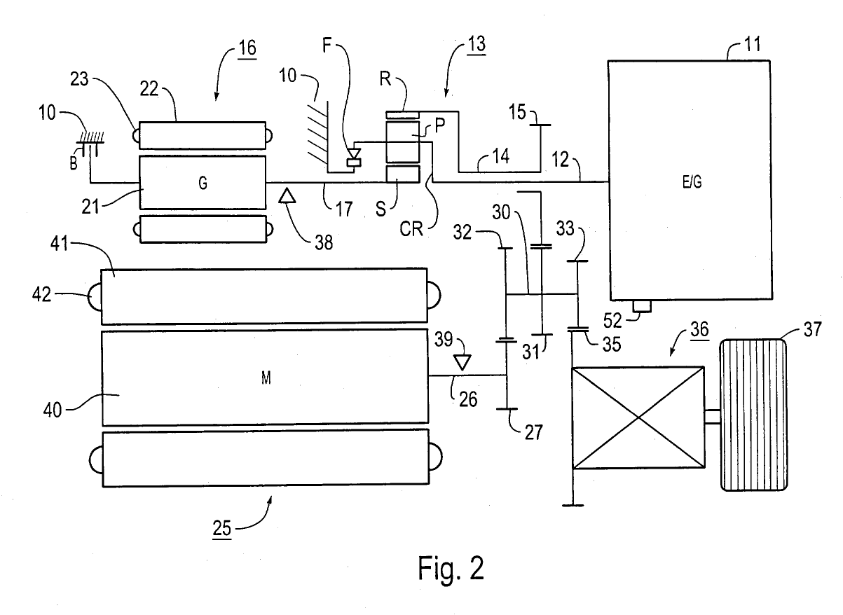

FIG. 2 is a conceptual diagram of a hybrid vehicle according to a first embodiment of the invention. In the figure, reference numeral 11 denotes an engine (E/G) provided on a first axis; reference numeral 12 denotes an output shaft provided on the first axis that outputs rotation generated by the drive of the engine 11; reference numeral 13 denotes a planetary gear unit provided on the first axis which is a differential gear unit that shifts in regard to a rotation input via the output shaft 12; reference numeral 14 denotes an output shaft provided on the first axis that outputs the rotation after shifting of the planetary gear unit 13; reference numeral 15 denotes a first counter drive gear which is an output gear fixed to the output shaft 14; reference numeral 16 denotes a generator (G), provided on the first axis, which is a first electric machine that is connected with the planetary gear unit 13 via a transfer shaft 17 and is further mechanically connected with the engine 11 in a manner allowing differential rotation. In addition, the generator 16 is mechanically connected with a drive wheel 37, which is a wheel.

The output shaft 14 has a sleeve shape and is provided encircling the output shaft 12. Also, the first counter drive gear 15 is provided closer to the engine 11 side than the planetary gear unit 13.

The planetary gear unit 13 is equipped with at least a sun gear S which is a first gear element, a pinion P that meshes with the sun gear S, a ring gear R which is a second gear element that meshes with the pinion P, and a carrier CR which is a third gear element that rotatably supports the pinion P. The sun gear S is connected with the generator 16 via the transfer shaft 17, and the ring gear R is connected, via the output shaft 14 and a predetermined gear train, with the drive wheel 37 and the drive motor (M) 25 which is a second electric machine that is provided on a second axis parallel to the first axis, and is mechanically connected with the engine 11 and the generator 16 in a manner allowing differential rotation Furthermore, the carrier CR is connected with the engine 11 via the output shaft 12. The drive motor 25 is mechanically connected with the drive wheel 37. Also, a one-way clutch F is provided between the carrier CR and a case 10 of a hybrid vehicle drive device, which is a vehicle drive device. The one-way clutch F becomes free when forward rotation from the engine 11 is transmitted to the carrier CR, and locked when reverse rotation from the generator 16 or the drive motor 25 is transmitted to the carrier CR, thereby stopping the rotation of the engine 11 so that the reverse rotation is not transmitted to the engine 11. Accordingly, when the generator 16 is driven while the drive of the engine 11 is stopped, a reaction force is applied through the one-way clutch F to the torque transmitted from the generator 16. In place of the one-way clutch F, a brake (not shown) can be provided as a stopping mechanism between the carrier CR and the case 10.

The generator 16 is fixed to the transfer shaft 17 and includes a rotor 21 that is provided rotatably, a stator 22 that is provided around the rotor 21, and a coil 23 that is wound around the stator 22. The generator 16 generates electric power through the rotation transmitted via the transfer shaft 17. The coil 23 is connected to a battery (not shown) and supplies a direct current to the battery. A generator brake B is provided between the rotor 21 and the case 10, and by engaging the generator brake B, the rotor 21 is fixed and the rotation of the generator 16 can be mechanically stopped.

In addition, reference numeral 26 denotes an output shaft provided on the second axis that outputs the rotation of the drive motor 25, and reference numeral 27 denotes a second counter drive gear which is an output gear that is fixed to the output shaft 26. The drive motor 25 includes a rotor 40 that is fixed to the output shaft 26 and provided rotatably, a stator 41 that is provided around the rotor 40, and a coil 42 that is wound around the stator 41.

The drive motor 25 generates a drive motor torque TM through the phase U, V, and W electric currents that are alternating currents supplied to the coil 42. Therefore, the coil 42 is connected to the battery, so that the direct current from the battery is converted into electric current of each phase and supplied to the coil 42.

In order to rotate the drive wheel 37 in the same direction of rotation as the engine 11, a counter shaft 30 is provided on a third axis parallel to the first and second axes. Furthermore, a first counter driven gear 31 and a second counter driven gear 32 that has more teeth than the first counter driven gear 31 are fixed to the counter shaft 30. The first counter driven gear 31 and the first counter drive gear 15, and the second counter driven gear 32 and the second counter drive gear 27 are meshed respectively, such that the rotation of the first counter drive gear 15 is reversed, so as to be transmitted to the first counter driven gear 31 and the rotation of the second counter drive gear 27 is reversed so as to be transmitted to the second counter driven gear 32. Furthermore, a differential pinion gear 33 that has fewer teeth than the first counter driven gear 31 is fixed to the counter shaft 30.

A differential device 36 is provided on a fourth axis parallel to the first, second, and third axes, and a differential ring gear 35 of the differential device 36 is meshed with the differential pinion gear 33. Accordingly, rotation transmitted to the differential ring gear 35 is distributed and transmitted to the drive wheel 37 by the differential device 36. Thus, not only can rotation generated by the engine 11 be transmitted to the first counter driven gear 31, but rotation generated by the drive motor 25 can also be transmitted to the second counter driven gear 32, therefore the hybrid vehicle is capable of running on the drive of both the engine 11 and the drive motor 25.

In this case, reference numeral 38 denotes a generator rotor position sensor such as a resolver that detects the position of the rotor 21, i.e. a generator rotor position θG, and reference numeral 39 denotes a drive motor rotor position sensor such as a resolver that detects the position of the rotor 40, i.e. a drive motor rotor position θM. The detected generator rotor position θG is sent to a vehicle control device (not shown) and a generator control device (not shown). The drive motor rotor position θM is sent to the vehicle control device and a drive motor control device (not shown). Furthermore, reference numeral 52 denotes an engine rotational speed sensor which is an engine rotational speed detection portion that detects a rotational speed of the engine 11, i.e. an engine rotational speed NE. The engine rotational speed NE is sent to the vehicle control device and an engine control device (not shown).

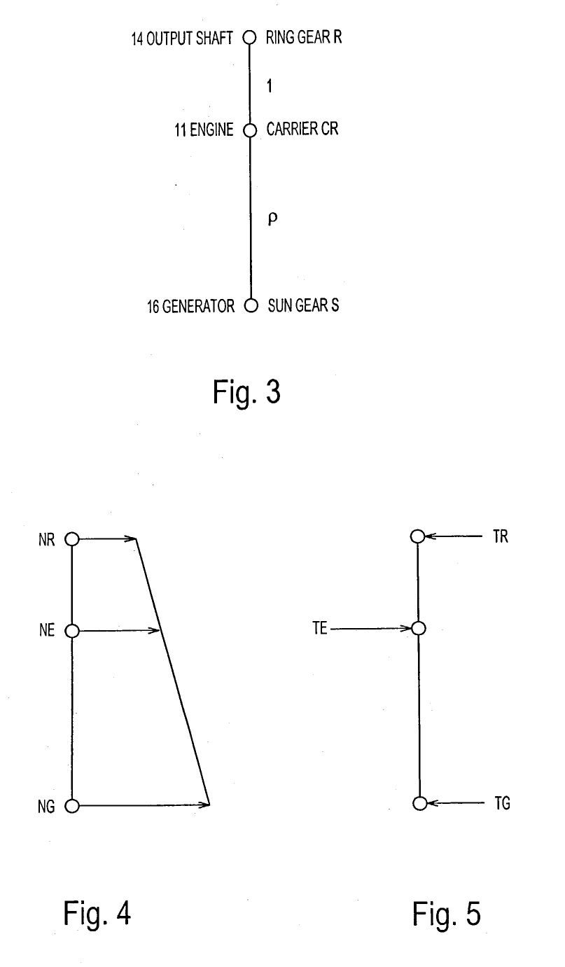

Next, the operation of the aforementioned planetary gear unit 13 will be described. FIG. 3 is an operation explanatory drawing of a planetary gear unit according to the first embodiment of the invention, and FIG. 4 is a line drawing of vehicle speeds during normal running periods according to the first embodiment of the invention. FIG. 5 is a line drawing of torque during normal running periods according to the first embodiment of the invention.

In the planetary gear unit 13 (FIG. 2), the carrier CR is connected with the engine 11, the sun gear S is connected with the generator 16, and the ring gear R is connected with the drive motor 25 and the drive wheel 37 via the output shaft 14 and a predetermined gear train. Therefore, a rotational speed of the ring gear R, i.e. a ring gear rotational speed NR, and a rotational speed output to the output shaft 14, i.e. output shaft rotational speed are equal, and a rotational speed of the carrier CR and the engine rotational speed NE are equal. Furthermore, a rotational speed of the sun gear S and a rotational speed of the generator 16, i.e. a generator rotational speed NG which is a first electric machine rotational speed are equal. When the number of teeth of the ring gear R is ρ times the number of teeth of the sun gear S (two times in the embodiment), the relationship,

(ρ+1)·NE=1·NG+ρ·NR

is established. Accordingly, based on the ring gear rotational speed NR and the generator rotational speed NG, the engine rotational speed NE,

NE=(1·NG+ρ·NR)/(ρ+1) (1)

can be calculated. In this case, the rotational speed relational expression of the planetary gear unit 13 is constructed according to formula (1).

In addition, an engine torque TE, a torque generated by the ring gear R, i.e. a ring gear torque TR, and a torque of the generator 16, i.e. a generator torque TG, which is the first electric machine torque have the relationship,

TE:TR:TG=(ρ+1):ρ:1 (2)

and receive reaction forces from each other. In this case, the torque relational expression of the planetary gear unit 13 is constructed according to formula (2).

During a normal running period of the hybrid vehicle, each of the ring gear R, the carrier CR, and the sun gear S are rotated in the positive direction, and as shown in FIG. 4, each of the ring gear rotational speed NR, the engine rotational speed NE, and the generator rotational speed NG assumes a positive value. In addition, the ring gear torque TR and the generator torque TG are obtained by proportionally dividing the engine torque TE by the torque ratio determined by the number of teeth in the planetary gear unit 13. Therefore, in the torque line drawing shown in FIG. 5, the sum of the ring gear torque TR and the generator torque TG is equal to the engine torque TE.

Next, the hybrid vehicle drive control device, which is an electric vehicle drive control device, that controls the hybrid vehicle drive device will be described.

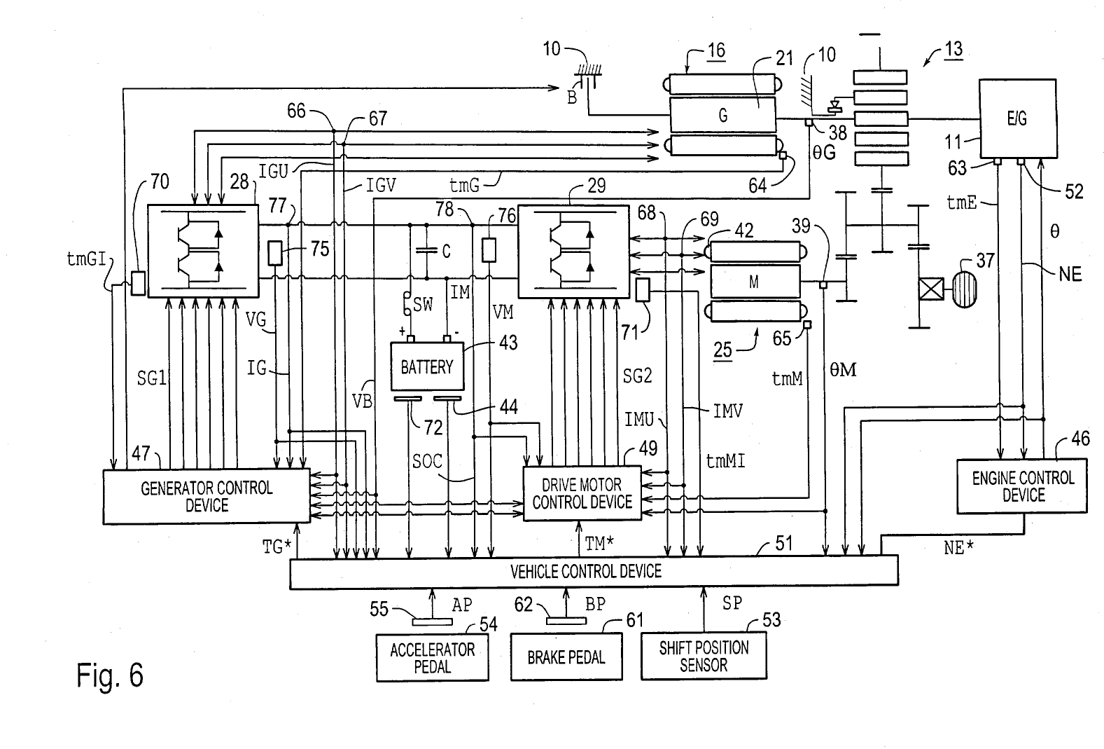

FIG. 6 is a conceptual diagram of a hybrid vehicle drive control device according to the first embodiment of the invention. In the figure, reference numeral 10 denotes the case; reference numeral 11 denotes the engine (E/G); reference numeral 13 denotes the planetary gear unit; reference numeral 16 denotes the generator (G); reference symbol B denotes the generator brake for fixing the rotor 21 of the generator 16; reference numeral 25 denotes the drive motor (M); reference numeral 28 denotes an inverter which is a generator inverter for driving the generator 16; reference numeral 29 denotes an inverter which is a drive motor inverter for driving the drive motor 25; reference numeral 37 denotes the drive wheel; reference numeral 38 denotes the generator rotor position sensor; reference numeral 39 denotes the drive motor rotor position sensor; and reference numeral 43 denotes the battery. The inverters 28 and 29 are connected to the battery 43 via a power switch SW, and when the power switch SW is on, the battery 43 supplies a direct current to the inverters 28 and 29. Each of the inverters 28 and 29 is equipped with a plurality of, for example, six transistors as switching elements, and each transistor is paired as a unit to construct a transistor module (IGBT) of each phase.

On the input port side of the inverter 28, a generator inverter voltage sensor 75 which is a first direct current voltage detection portion for detecting a direct current voltage applied to the inverter 28, i.e. a generator inverter voltage VG, and a generator inverter electric current sensor 77 which is a first direct current detection portion for detecting a direct current supplied to the inverter 28, i.e. a generator inverter electric current IG, are provided. In addition, the input port side of the inverter 29 is provided with a drive motor inverter voltage sensor 76 which is a second direct current voltage detection portion for detecting a direct current voltage applied to the inverter 29, i.e. a drive motor inverter voltage VM, and a drive motor inverter electric current sensor 78 which is a second direct current detection portion for detecting a direct current supplied to the inverter 29, i.e. a drive motor inverter electric current IM. The generator inverter voltage VG and the generator inverter electric current IG are sent to a vehicle control device 51 and a generator control device 47, while the drive motor inverter voltage VM and the drive motor inverter electric current IM are sent to the vehicle control device 51 and a drive motor control device 49. A smoothing capacitor C is connected between the battery 43 and the inverters 28 and 29.

Also, the vehicle control device 51 includes a CPU, recording equipment, and the like (not shown), controls the entire hybrid vehicle drive device, and functions as a computer in accordance with certain programs, data, and the like. An engine control device 46, the generator control device 47, and the drive motor control device 49 are connected to the vehicle control device 51. The engine control device 46 includes a CPU, recording equipment, and the like (not shown), and sends command signals such as throttle opening θ and valve timing to the engine 11 and the vehicle control device 51 in order to control the engine 11. The generator control device 47 includes a CPU, recording equipment, and the like (not shown), and sends a drive signal SG1 to the inverter 28 in order to control the generator 16. Furthermore, the drive motor control device 49 includes a CPU, recording equipment, and the like (not shown), and sends a drive signal SG2 to the inverter 29 in order to control the drive motor 25. In this case, the engine control device 46, the generator control device 47, and the drive motor control device 49 constitute a first control device that is subordinate to the vehicle control device 51, and the vehicle control device 51 constitutes a second control device that is superordinate to the engine control device 46, the generator control device 47, and the drive motor control device 49. In addition, the engine control device 46, the generator control device 47, and the drive motor control device 49 also function as computers in accordance with certain programs, data, and the like.

The inverter 28 is driven according to the drive signal SG1, and receives a direct current from the battery 43 during powering, thereby generating the electric current IGU, IGV, and IGW of each phase, and supplying the electric current IGU, IGV, and IGW of each phase to the generator 16. During regeneration, the inverter 28 receives the electric current IGU, IGV, and IGW of each phase from the generator 16, and generates a direct current which is supplied to the battery 43.

The inverter 29 is driven according to the drive signal SG2, and receives a direct current from the battery 43 during powering, thereby generating electric current IMU, IMV, and IMW of each phase, and supplying the electric current IMU, IMV, and IMW of each phase to the drive motor 25. During regeneration, the inverter 29 receives the electric current IMU, IMV, and IMW of each phase from the drive motor 25, and generates a direct current which is supplied to the battery 43.

Furthermore, reference numeral 44 denotes a battery remaining charge detection device that detects a state of the battery 43, i.e. a battery remaining charge SOC which is a battery state; reference numeral 52 denotes the engine rotational speed sensor that detects the engine rotational speed NE; reference numeral 53 denotes a shift position sensor that detects the position of a shift lever (not shown) which is a speed selecting operation mechanism, i.e. a shift position SP; reference numeral 54 denotes an accelerator pedal; reference numeral 55 denotes an accelerator switch which is an accelerator operation detection portion that detects a position (amount of depression) of the accelerator pedal 54, i.e. an accelerator pedal position AP; reference numeral 61 denotes a brake pedal; reference numeral 62 denotes a brake switch which is a brake operation detection portion that detects a position (amount of depression) of the brake pedal 61, i.e. a brake pedal position BP; reference numeral 63 denotes an engine temperature sensor that detects a temperature tmE of the engine 11; reference numeral 64 denotes a generator temperature sensor that detects a temperature of the generator 16, for example, a temperature tmG of the coil 23 (FIG. 2); reference numeral 65 denotes the drive motor temperature sensor that detects the temperature of the drive motor 25, for example, a temperature tmM of the coil 42; reference numeral 70 denotes a first inverter temperature sensor that detects a temperature tmGI of the inverter 28; and reference numeral 71 denotes a second inverter temperature sensor that detects a temperature tmMI of the inverter 29.

The generator 16, the inverter 28, and the like constitute a first electric machine drive portion, and the drive motor 25, the inverter 29, and the like constitute a second electric machine drive portion. The temperatures tmG, tmGI and the like are detected as the temperature of the first electric machine drive portion, i.e. a first drive portion temperature, and the aforementioned temperatures tmM, tmMI and the like are detected as the temperature of the second electric machine drive portion, i.e. a second drive portion temperature. Then the temperatures tmG, tmGI and the like are sent to the generator control device 47, and the temperatures tmM, tmMI and the like are sent to the drive motor control device 49. Also, by a first and second oil temperature sensors (not shown), a temperature tmGO of oil for cooling the generator 16, a temperature tmMO of oil for cooling the drive motor 25, and the like may be detected as a first and a second drive portion temperature respectively. Furthermore, the generator temperature sensor 64, the first inverter temperature sensor 70, the first oil temperature sensor, and the like constitute a first drive portion temperature detection portion, and the drive motor temperature sensor 65, the second inverter temperature sensor 71, the second oil temperature sensor, and the like constitute a second drive portion temperature detection portion.

Furthermore, reference numerals 66 to 69 denote electric current sensors which are alternating current detection portions that detect electric currents IGU, IGV, IMU, and IMV of each phase, respectively, and reference numeral 72 denotes a battery voltage sensor which is a voltage detection portion for the battery 43 that detects a battery voltage VB which is the battery state. The battery voltage VB and the battery remaining charge SOC are sent to the generator control device 47, the drive motor control device 49, and the vehicle control device 51. In addition, battery electric current, battery temperature, and the like may be detected as battery states. The battery remaining charge detection device 44, the battery voltage sensor 72, a battery electric current sensor (not shown), a battery temperature sensor (not shown), and the like constitute a battery state detection portion. Also, the electric currents IGU, and IGV are supplied to the generator control device 47 and the vehicle control device 51, while the electric currents IMU and IMV are supplied to the drive motor control device 49 and the vehicle control device 51.

The vehicle control device 51 sends an engine control signal to the engine control device 46 so as to cause the engine control device 46 to set the starting and stopping of the engine 11. Furthermore, a vehicle speed calculation processing mechanism (not shown) of the vehicle control device 51 executes a vehicle speed calculation process to calculate a changing rate ΔθM of the drive motor rotor position θM, and calculates the vehicle speed V based on the changing rate ΔθM and a gear ratio γV of the torque transmission system from the output shaft 26 to the drive wheel 37.

Then, the vehicle control device 51 sets an engine target rotational speed NE* that indicates a target value for the engine rotational speed NE, a generator target torque TG* which is a first electric machine target torque that indicates a target value of the generator torque TG, and a drive motor target torque TM* which is a second electric machine target torque that indicates a target value of the drive motor torque TM. The generator control device 47 sets a generator target rotational speed NG* that indicates a target value for the generator rotational speed NG, and the drive motor control device 49 sets a drive motor torque compensation value δTM that indicates a compensation value of the drive motor torque TM. In this case, a control command value is constituted by the engine target rotational speed NE*, the generator target torque TG*, the drive motor target torque TM*, and the like.

In addition, a generator rotational speed calculation processing mechanism (not shown) of the generator control device 47 executes a generator rotational speed calculation process to calculate the generator rotational speed NG by reading the generator rotor position θG and calculating a changing rate ΔθG of the generator rotor position θG.

Furthermore, a drive motor rotational speed calculation processing mechanism (not shown) of the drive motor control device 49 executes a calculation process of the drive motor rotational speed which is the rotational speed of the second electric machine to calculate the drive motor rotational speed NM which is the rotational speed of the second electric machine by reading the drive motor rotor position θM and calculating a changing rate ΔθM of the drive motor rotor position θM.

Since the generator rotor position θG and the generator rotational speed NG are proportionate to each other, and the drive motor rotor position θM, the drive motor rotational speed NM, and the vehicle speed V are all proportionate to each other, the generator rotor position sensor 38 and the generator rotational speed calculation processing mechanism can function as a generator rotational speed detection portion that detects the generator rotational speed NG. Also, the drive motor rotor position sensor 39 and the drive motor rotational speed calculation processing mechanism can function as a drive motor rotational speed detection portion that detects the drive motor rotational speed NM. Furthermore, the drive motor rotor position sensor 39 and the vehicle speed calculation processing mechanism can function as a vehicle speed detection portion that detects the vehicle speed V.

In the embodiment, the engine rotational speed NE is detected by the engine rotational speed sensor 52, however, the engine rotational speed NE can also be calculated in the engine control device 46. Also, in the embodiment, the vehicle speed V is calculated by the vehicle speed calculation processing mechanism based on the drive motor rotor position θM, however, the vehicle speed V can also be calculated based on the detected ring gear rotational speed NR, or based on a rotational speed of the drive wheel 37, i.e. a drive wheel rotational speed. In this case, a ring gear rotational speed sensor, a drive wheel rotational speed sensor or the like are provided as a vehicle speed detection portion.

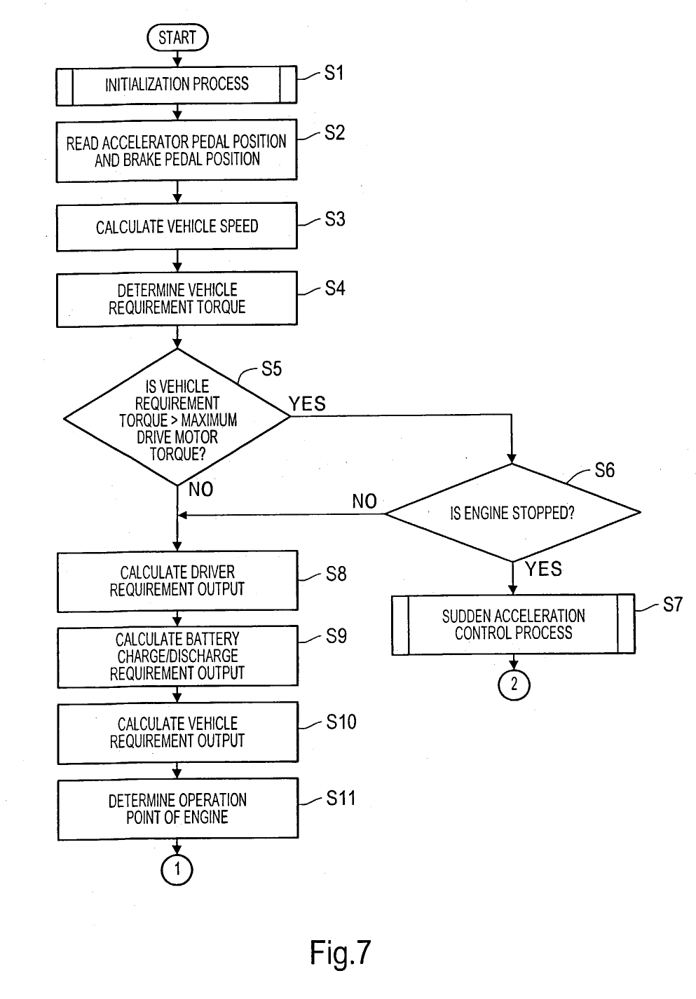

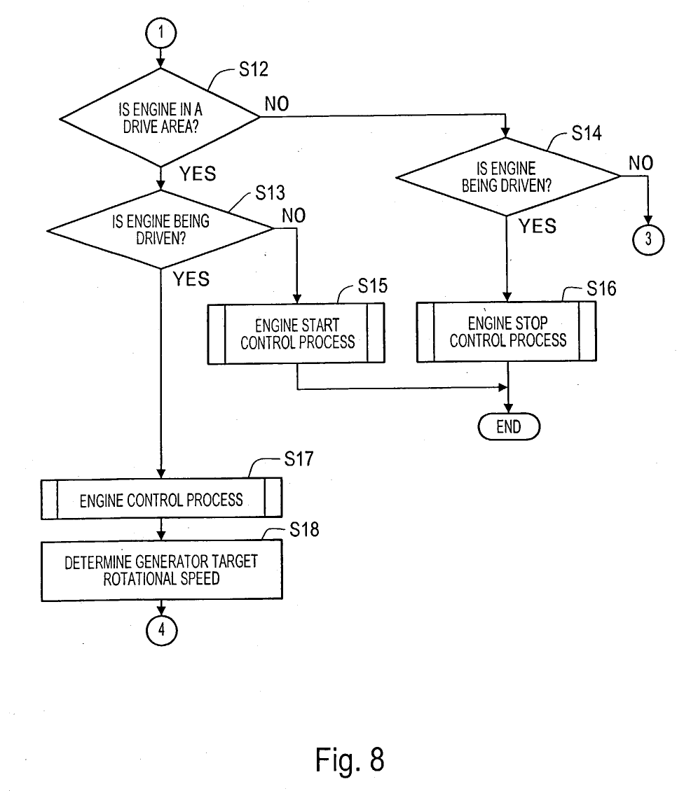

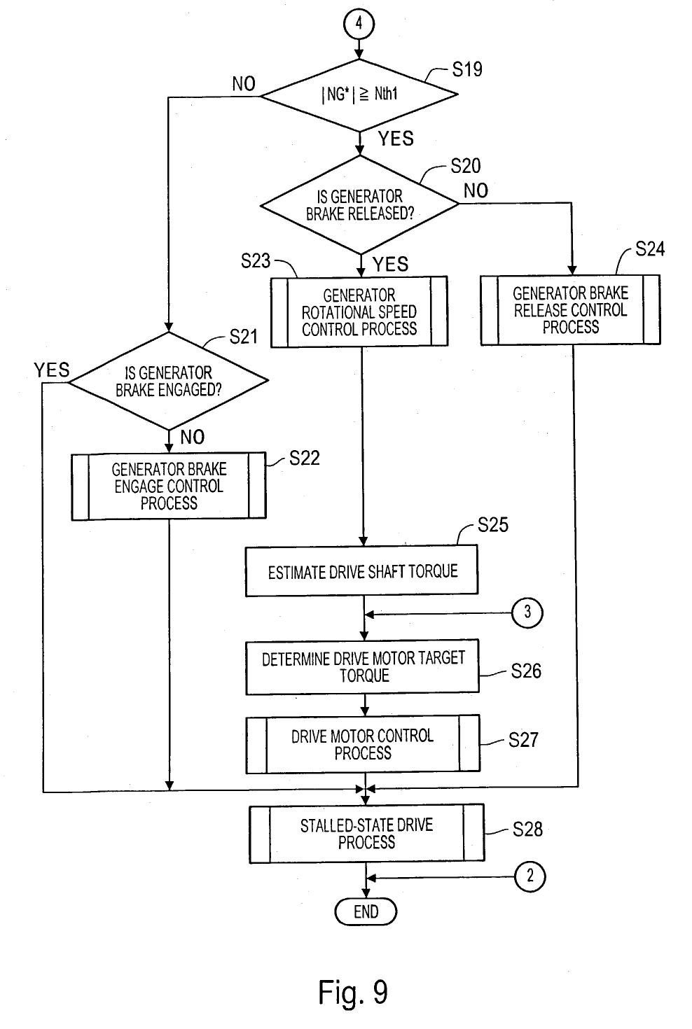

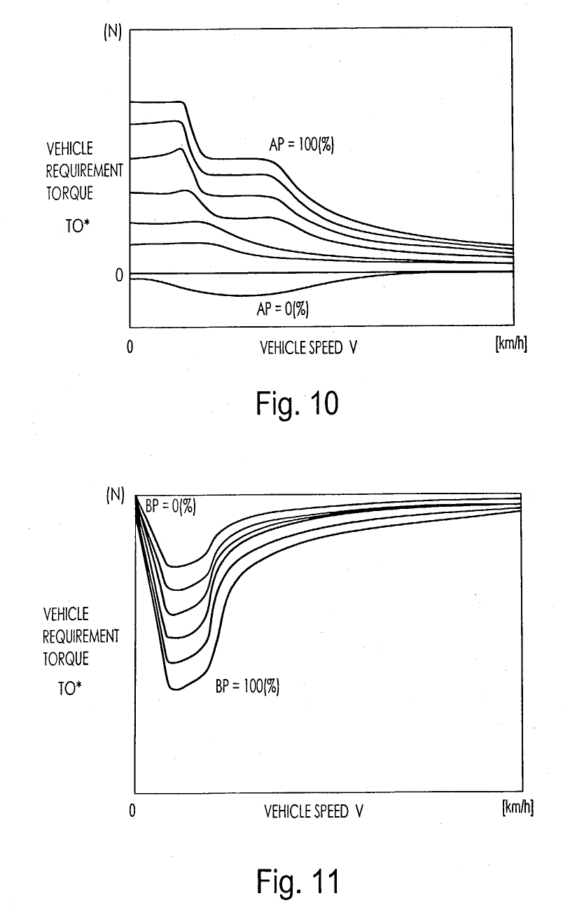

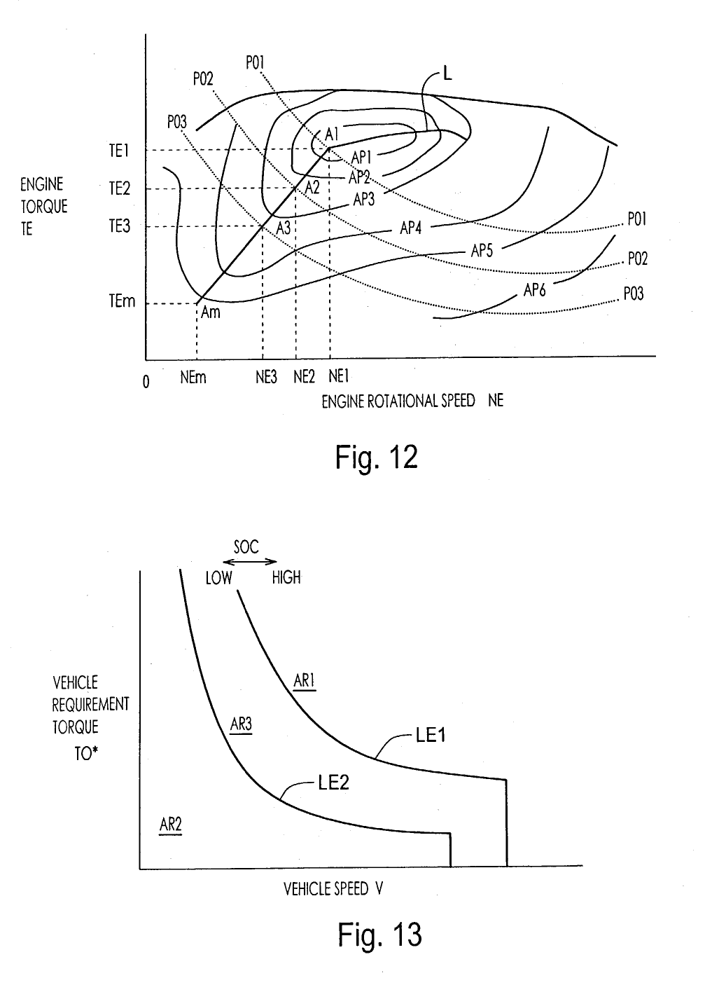

Next, an operation of a hybrid vehicle drive control device of the aforementioned structure will be described. FIG. 7 is a first main flow chart illustrating the operation of the hybrid vehicle drive control device according to the first embodiment of the invention; FIG. 8 is a second main flow chart illustrating the operation of the hybrid vehicle drive control device according to the first embodiment of the invention; FIG. 9 is a third main flow chart illustrating the operation of the hybrid vehicle drive control device according to the first embodiment of the invention; FIG. 10 is a drawing illustrating a first vehicle requirement torque map according to the first embodiment of the invention; FIG. 11 is a drawing illustrating a second vehicle requirement torque map according to the first embodiment of the invention; FIG. 12 is a drawing illustrating an engine target operation state map according to the first embodiment of the invention; and FIG. 13 is a drawing illustrating an engine drive area map according to the first embodiment of the invention. In FIGS. 10, 11, and 13, the x-axis is the vehicle speed V and the y-axis is a vehicle requirement torque TO*. In FIG. 12, the x-axis is the engine rotational speed NE, and the y-axis is the engine torque TE.

First, an initialization processing mechanism (not shown) of the vehicle control device 51 (FIG. 6) executes an initialization process to set each type of variable to a default value. Next, the vehicle control device 51 executes a vehicle requirement torque determination process, and reads the accelerator pedal position AP from the accelerator switch 55 and the brake pedal position BP from the brake switch 62. Then, the vehicle speed calculation processing mechanism reads the drive motor rotor position θM, calculates the changing rate ΔθM of the drive motor rotor position θM, and then calculates the vehicle speed V based on the changing rate ΔθM and the gear ratio γV.

Subsequently, a vehicle requirement torque determination processing mechanism (not shown) of the vehicle control device 51 executes the vehicle requirement torque determination process, and when the accelerator pedal 54 is pressed, it refers to the first vehicle requirement torque map in FIG. 10 which is recorded in the recording equipment of the vehicle control device 51, whereas when the brake pedal 61 is pressed, it refers to the second vehicle requirement torque map in FIG. 11 which is recorded in the recording equipment, in order to determine the necessary vehicle requirement torque TO* for running the hybrid vehicle which is preset to correspond with the accelerator pedal position AP, the brake pedal position BP, and the vehicle speed V.

Next, the vehicle control device 51 judges whether the vehicle requirement torque TO* is greater than a drive motor maximum torque TMmax that is preset as the rating of the drive motor 25. If the vehicle requirement torque TO* is greater than the drive motor maximum torque TMmax, then the vehicle control device 51 judges whether the engine 11 is stopped. If the engine 11 is stopped, then a sudden acceleration control processing mechanism (not shown) of the vehicle control device 51 executes a sudden acceleration control process, thereby driving the drive motor 25 and the generator 16 to run the hybrid vehicle.

Also, in a case where the vehicle requirement torque TO* is equal to or less than the drive motor maximum torque TMmax, and in a case where the vehicle requirement torque TO* is greater than the drive motor maximum torque TMmax but the engine 11 is not stopped, a driver requirement output calculation processing mechanism (not shown) of the vehicle control device 51 executes a driver requirement output calculation process to calculate a driver requirement output PD by multiplying the vehicle requirement torque TO* by the vehicle speed V:

PD=TO*·V

When comparing the vehicle requirement torque TO* and the drive motor maximum torque TMmax, in practical, the drive motor maximum torque TMmax is multiplied by a gear ratio γMA from the drive motor rotor position sensor 39 to the drive shaft of the drive wheel 37, and the vehicle requirement torque TO* is compared to the multiplied value. In this case, the first and second vehicle requirement torque map can be created with the gear ratio γMA being taken into account.

Next, a battery charge/discharge requirement output calculation processing mechanism (not shown) of the vehicle control device 51 executes a battery charge/discharge requirement output calculation process to calculate a battery charge/discharge requirement output PB based on the battery remaining charge SOC by reading the battery remaining charge SOC from the battery remaining charge detection device 44.

Thereafter, a vehicle requirement output calculation processing mechanism (not shown) of the vehicle control device 51 executes a vehicle requirement output calculation process, and by adding the driver requirement output PD and the battery charge/discharge requirement output PB, calculates a vehicle requirement output PO:

PO=PD+PB

Next, an engine target operation state setting processing mechanism (not shown) of the vehicle control device 51 executes an engine target operation state setting process, and refers to the engine target operation state map in FIG. 12 which is recorded in the recording equipment of the vehicle control device 51 to determine, as operation points of the engine 11 which are engine target operation states, the points A1 to A3, and Am at which the lines PO1, PO2, and the like which indicate the vehicle requirement output PO intersect the optimum fuel consumption curve L where the engine 11 reaches maximum efficiency at each accelerator pedal position AP1 to AP6. Then, engine torque TE1 to TE3, and TEm at the operation point are determined as the engine target torque TE* which indicates the target value of the engine torque TE, and engine rotational speeds NE1 to NE3, and NEm at the operation point are determined as the engine target rotational speed NE*. Thereafter, the engine target rotational speed NE* is sent to the engine control device 46.

Then, the engine control device 46 refers to the engine drive area map in FIG. 13 which is recorded in the recording equipment of the engine control device 46 and judges whether the engine 11 is in a drive area AR1. In FIG. 13, AR1 is a drive area where the engine 11 is driven, AR2 is a stop area where the drive of the engine 11 is stopped, and AR3 is a hysteresis area. Furthermore, LE1 is a line where the stopped engine 11 is driven, and LE2 is a line where the drive of the driving engine 11 is stopped. As the battery remaining charge SOC becomes higher, the line LE1 is shifted to the right in FIG. 13, and the drive area AR1 becomes more narrow. On the other hand, as the battery remaining charge SOC becomes lower, the line LE1 is shifted to the left in FIG. 13, and the drive area AR1 becomes wider.

If the engine 11 is not being driven despite the engine 11 being in the drive area AR1, an engine start control processing mechanism (not shown) of the engine control device 46 executes an engine start control process and starts the engine 11. On the other hand, if the engine 11 is being driven despite the engine 11 not being in the drive area AR1, an engine stop control processing mechanism (not shown) of the engine control device 46 executes an engine stop control process and stops the drive of the engine 11. Furthermore, if the engine 11 is not being driven with the engine 11 not in the drive area AR1, a drive motor target torque calculation processing mechanism (not shown) of the vehicle control device 51 executes a drive motor target torque calculation process to calculate and determine the vehicle requirement torque TO* as the drive motor target torque TM*, and sends the drive motor target torque TM* to the drive motor control device 49. The drive motor control processing mechanism of the drive motor control device 49 executes a drive motor control process and controls the torque of the drive motor 25.

In addition, when the engine 11 is in the drive area AR1 and the engine 11 is being driven, an engine control processing mechanism (not shown) of the engine control device 46 executes an engine control process and controls the engine 11 by a predetermined method.

Next, a generator target rotational speed calculation processing mechanism (not shown) of the generator control device 47 executes a generator target rotational speed calculation process. Specifically, the drive motor rotor position θM is read through the vehicle control device 51, and the ring gear rotational speed NR is calculated based on the drive motor rotor position θM and a gear ratio γR from the output shaft 26 (FIG. 2) to the ring gear R. Also, the engine target rotational speed NE* set through the engine target operation state setting process is read, and the generator target rotational speed NG* is calculated and determined, using the rotational speed relational expression, based on the ring gear rotational speed NR and the engine target rotational speed NE*.

Meanwhile, when the generator rotational speed NG is low while the hybrid vehicle of the aforementioned structure is run by the drive motor 25 and the engine 11, power consumption increases, thereby reducing the power generation efficiency of the generator 16 and causing the fuel efficiency of the hybrid vehicle to become that much worse. Therefore, when the absolute value of the generator target rotational speed NG* indicating the generator rotational speed NG is lower than a predetermined rotational speed, the generator brake B is engaged, thereby mechanically stopping the generator 16 so as to improve fuel efficiency.

For that purpose, the generator control device 47 judges whether the absolute value of the generator target rotational speed NG* is equal to or higher than a predetermined first rotational speed Nth1 (for example, 500 [rpm]). If the absolute value of the generator target rotational speed NG* is equal to or higher than the first rotational speed Nth1, the generator control device 47 judges whether the generator brake B is released. Then, if the generator brake B is released, a generator rotational speed control processing mechanism (not shown) of the generator control device 47 executes a generator rotational speed control process and controls the torque of the generator 16. On the other hand, if the generator brake B has not been released, a generator brake release control processing mechanism (not shown) of the generator control device 47 executes a generator brake release control process and releases the generator brake B.

Meanwhile, in the generator rotational speed control process, when a predetermined generator torque TG is generated after the generator target torque TG* is determined and the torque of the generator 16 is controlled based on the generator target torque TG*, as described earlier, the engine torque TE, the ring gear torque TR, and the generator torque TG will receive reaction forces from each other, therefore, the generator torque TG is converted into the ring gear torque TR to be output from the ring gear R.

Then, if fluctuations in the generator rotational speed NG occurs along with the ring gear torque TR output from the ring gear R, and the ring gear torque TR fluctuates, the fluctuating ring gear torque TR is transmitted to the drive wheel 37 which deteriorates the running feeling of the hybrid vehicle. Therefore, the ring gear torque TR is calculated taking into account the torque corresponding to the inertia of the generator 16 (inertia of the rotor 21 and a rotor shaft) involved in the fluctuations of the generator rotational speed NG.

For that purpose, a ring gear torque calculation processing mechanism (not shown) of the vehicle control device 51 executes a ring gear torque calculation process, reads the generator target torque TG*, and calculates the ring gear torque TR based on the generator target torque TG* and the ratio of the number of ring gear R teeth to the number of sun gear S teeth.

Namely, when InG is the inertia of the generator 16 and αG is the angular acceleration (rotation changing rate) of the generator 16, torque applied to the sun gear S, i.e. a sun gear torque TS is obtained by adding a torque equivalent component (inertia torque) TGI corresponding to the inertia InG to the generator target torque TG*:

TGI=InG·αG

thereby becoming:

$$\begin{matrix}TS = {TG}^{*} + TGI \\ = {TG}^{*} + InG \cdot α G\end{matrix} \qquad ( 3 )$$

The torque equivalent component TGI usually assumes a negative value in the direction of acceleration while the hybrid vehicle is accelerating and assumes a positive value in the direction of acceleration when the hybrid vehicle is decelerating. Also, the angular acceleration αG is calculated by differentiating the generator rotational speed NG.

When the number of ring gear R teeth is ρ times greater than the number of sun gear S teeth, the ring gear torque TR is ρ times the sun gear torque TS, therefore TR becomes:

$$\begin{matrix}TR = ρ \cdot TS \\ = ρ \cdot ( {TG}^{*} + TGI ) \\ = ρ \cdot ( {TG}^{*} + InG \cdot α G )\end{matrix} \qquad ( 4 )$$

As shown above, the ring gear torque TR can be calculated from the generator target torque TG* and the torque equivalent component TGI.

Therefore, a drive shaft torque estimation processing mechanism (not shown) of the drive motor control device 49 executes a drive shaft torque estimation process, and estimates a torque of the output shaft 26, i.e. a drive shaft torque TR/OUT, based on the generator target torque TG* and the torque equivalent component TGI. Namely, the drive shaft torque estimation processing mechanism estimates and calculates the drive shaft torque TR/OUT based on the ring gear torque TR and the ratio of the number of second counter drive gear 27 teeth to the number of ring gear R teeth.

Meanwhile, at the time the generator brake B is engaged, the generator target torque TG* becomes zero (0), therefore the ring gear torque TR takes on a proportional relationship with the engine torque TE. So when the generator brake B is engaged, the drive shaft torque estimation processing mechanism reads the engine torque TE through the vehicle control device 51, calculates the ring gear torque TR based on the engine torque TR using the aforementioned torque relational expression, and estimates the drive shaft torque TR/OUT based on the ring gear torque TR and the ratio of the number of second counter drive gear 27 teeth to the number of ring gear R teeth.

Subsequently, the drive motor target torque calculation processing mechanism executes a drive motor target torque calculation process, and by subtracting the drive shaft torque TR/OUT from the vehicle requirement torque TO*, calculates and determines the excessive or deficient amount in the drive shaft torque TR/OUT as the drive motor target torque TM*.

Then, the drive motor control processing mechanism executes a drive motor control process, and controls the torque of the drive motor 25 based on the determined drive motor target torque TM* to control the drive motor torque TM.

In addition, when the absolute value of the generator target rotational speed NG* is smaller than the first rotational speed Nth1, the generator control device 47 judges whether the generator brake B is engaged. If the generator brake B is not engaged, then a generator brake engage control processing mechanism (not shown) of the generator control device 47 executes a generator brake engage control process and engages the generator brake B.

Meanwhile, when the drive motor 25 is driven to drive the hybrid vehicle, the hybrid vehicle stops if the wheels thereof (not necessarily the drive wheel 37) are caught in a groove or ride over curbs, and, even if the driver further presses the accelerator pedal 54, the hybrid vehicle is incapable of moving. With the hybrid vehicle is left in a stalled state, the drive motor 25 continues to be driven at a high load, therefore, a large electric current is continuously flowing to a transistor module of a certain phase, thereby overheating the transistor modules and not only shortening the life of the transistor modules, but generating abnormalities in the drive motor 25 as well.

Therefore, a stalled-state drive processing mechanism (not shown) of the vehicle control device 51 executes a stalled-state drive process and judges whether the hybrid vehicle is in the stalled state. If in the stalled state, it controls the drive motor target torque TM*, and also compensates and changes the generator target torque TG*. Accordingly, the generator 16 is accessorily driven, creating a state in which both the generator 16 and the drive motor 25 are driven, that is, a dual-motor driven state, and therefore the hybrid vehicle is freed from its stalled state. In the embodiment, although the generator 16 is driven as an auxiliary drive source in the dual-motor drive state, an auxiliary drive motor may be used in place of the generator 16 as the first electric machine, and the auxiliary drive motor may be driven as an auxiliary drive source.

Next, the flow charts in FIGS. 7 to 9 will be described. At Step S1, initialization process is executed, in Step S2, the accelerator pedal position AP and the brake pedal position BP are read, in Step S3, the vehicle speed V is calculated, and in Step S4, the vehicle requirement torque TO* is determined. In Step S5, a determination is made whether the vehicle requirement torque TO* is larger than the drive motor maximum torque TMmax. If the vehicle requirement torque TO* is larger than the drive motor maximum torque TMmax, the process proceeds to step S6. If the vehicle requirement torque TO* is equal to or less than the drive motor maximum torque TMmax, the process proceeds to step S8.

In Step S6, a determination is made whether the engine 11 is stopped. If the engine 11 is stopped, the process proceeds to step S7. If the engine is not stopped, the process proceeds to step S8. In Step S7, a sudden acceleration control process is executing, and the process end.

In Step S8, the driver requirement output PD is calculated, in Step S9, the battery charge/discharge requirement output PB is calculated, in Step S10, the vehicle requirement output PO is calculated, and in Step S11, the operation point of the engine 11 is determined. In Step S12, a determination is made whether the engine 11 is in the drive area AR1. If the engine 11 is in the drive area AR1, the process proceeds to step S13. If not, the process proceeds to step S14. In Step S13, a determination is made whether the engine 11 is being driven. If the engine 11 is being driven, the process proceeds to step S17. If not being driven (if it is stopped), the process proceeds to step S15.

In Step S14, a determination is made whether the engine 11 is being driven. If the engine 11 is being driven, the process proceeds to step S16. If not being driven, the process proceeds to step S26. In Step S15, engine start control process is executed, in Step S16, engine stop control process is executed, in Step S17, engine control process is executed, and in Step S18, the generator target rotational speed NG* is determined. In Step S19, a determination is made whether the absolute value of the generator target rotational speed NG* is equal to or higher than the first rotational speed Nth1. If the absolute value of the generator target rotational speed NG* is equal to or higher than the first rotational speed Nth1, the process proceeds to step S20. If the absolute value of the generator target rotational speed NG* is smaller than the first rotational speed Nth1, the process proceeds to step S21.

In Step S20, a determination is made whether the generator brake B is released. If the generator brake B is released, the process proceeds to step S23. If not released, the process proceeds to step S24. In Step S21, a determination is made whether the generator brake B is engaged. If the generator brake B is engaged, the process proceeds to step S28. If not engaged, the process proceeds to step S22. In Step S22, generator brake engage control process is executed, in Step S23, generator rotational speed control process is executed, in Step S24, generator brake release control process is executed, in Step S25, the drive shaft torque TR/OUT is estimated, in Step S26, the drive motor target torque TM* is determined, in Step S27, the drive motor control process is executed, in Step S28, stalled-state drive process is executed, and the process ends.

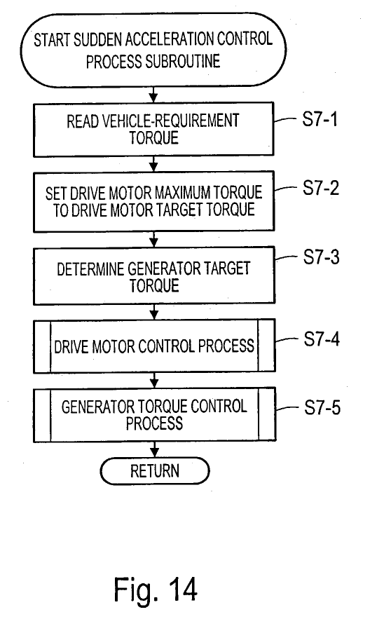

Next, a subroutine of the sudden acceleration control process in step S7 of FIG. 7 will be described. FIG. 14 is a drawing illustrating the subroutine of the sudden acceleration control process according to the first embodiment of the invention.

First, the sudden acceleration control processing mechanism reads the vehicle requirement torque TO* and sets the drive motor maximum torque TMmax as the drive motor target torque TM*. Then, a generator target torque calculation processing mechanism (not shown) of the vehicle control device 51 (FIG. 6) executes a generator target torque calculation process, in which it calculates a differential torque ΔT of the vehicle requirement torque TO* and the drive motor target torque TM*, and calculates and determines as the generator target torque TG* the amount that the drive motor maximum torque TMmax which is the drive motor target torque TM* is deficient, and sends the generator target torque TG* to the generator control device 47.

Then, the drive motor control processing mechanism executes the drive motor control process, and controls the torque of the drive motor 25 based on the drive motor target torque TM*. Furthermore, a generator torque control processing mechanism (not shown) of the generator control device 47 executes a generator torque control process, and controls the torque of the generator 16 based on the generator target torque TG*.

Next, the flow chart will be described. In Step S7-1, the vehicle requirement torque TO* is read, in Step S7-2, the drive motor maximum torque TMmax as the drive motor target torque TM* is set, in Step S7-3, the generator target torque TG* is calculated and determined, in Step S7-4, the drive motor control process is executed, in Step S7-5, generator torque control process is executed and the process returns.

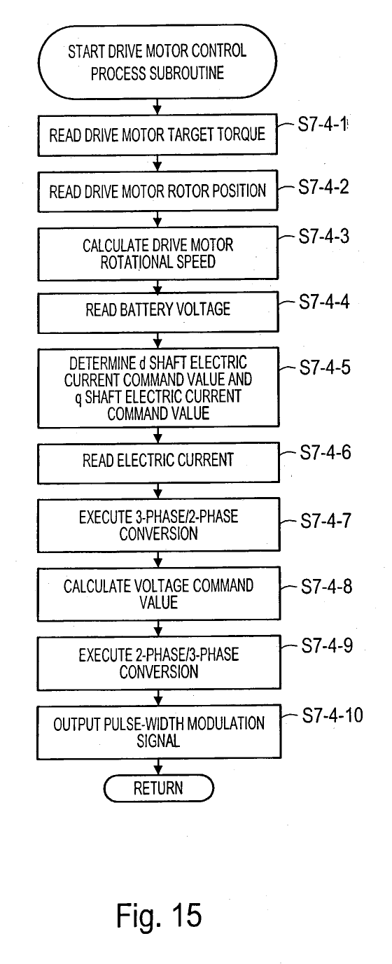

Next, a subroutine of the drive motor control process in step S27 of FIG. 9 and step S7-4 of FIG. 14 will be described. FIG. 15 is a drawing illustrating the subroutine of the drive motor control process according to the first embodiment of the invention. First, the drive motor control processing mechanism reads the drive motor target torque TM*. Next, the drive motor rotational speed calculation processing mechanism reads the drive motor rotor position θM, and calculates the drive motor rotational speed NM by calculating the changing rate ΔθM of the drive motor rotor position θM. Then, the drive motor control processing mechanism reads the battery voltage VB. In this case, the drive motor rotational speed NM and the battery voltage VB constitute an actual measurement value.

Next, the drive motor control processing mechanism calculates and determines a d shaft electric current command value IMd* and a q shaft electric current command value IMq* based on the drive motor target torque TM*, the drive motor rotational speed NM, and the battery voltage VB, with reference to the electric current command value map for drive motor control recorded in the recording equipment of the drive motor control device 49 (FIG. 6). In this case, the d shaft electric current command value IMd* and the q shaft electric current command value IMq* constitute an alternating current command value for the drive motor 25.

Furthermore, the drive motor control processing mechanism reads the electric currents IMU and IMV from the electric current sensors 68 and 69, and calculates the electric current IMW based on the electric currents IMU and IMV:

IMW=IMU−IMV

In this case, the electric current IMW may also be detected by an electric current sensor as is the case with the electric currents IMU and IMV.

Subsequently, an alternating current calculation processing mechanism (not shown) of the drive motor control processing mechanism executes an alternating current calculation process to calculate a d shaft electric current IMd and a q shaft electric current IMq by executing 3 phase/2 phase conversion and converting the electric currents IMU, IMV, and IMW into the d shaft electric current IMd and the q shaft electric current IMq which are alternating currents. Then, an alternating voltage command value calculation processing mechanism (not shown) of the drive motor control processing mechanism executes an alternating voltage command value calculation process, and calculates voltage command values VMd* and VMq* based on the d shaft electric current IMd and the q shaft electric current IMq, as well as the d shaft electric current command value IMd* and the q shaft electric current command value IMq*. Furthermore, the drive motor control processing mechanism executes 2 phase/3 phase conversion to convert the voltage command values VMd* and VMq* into the voltage command values VMU*, VMV*, and VMW*, calculates pulse-width modulation signals SU, SV, and SW based on the voltage command values VMU*, VMV*, and VMW*, and outputs the pulse-width modulation signals SU, SV and SW to a drive processing mechanism (not shown) of the drive motor control device 49. The drive processing mechanism executes a drive process, and sends the drive signal SG2 to the inverter 29 based on the pulse-width modulation signals SU, SV, and SW. In this case, the voltage command values VMd* and VMq* constitute an alternating voltage command value for the drive motor 25.

Next, the flow chart will be described. In this case, since the same process is executed in step S27 and step S7-4, the step S7-4 will be described. In Step S7-4-1, the drive motor target torque TM* is read, in Step S7-4-2, the drive motor rotor position θM is read, in Step S7-4-3, the drive motor rotational speed NM is calculated, in Step S7-4-4, the battery voltage VB is read, and in Step S7-4-5, the d shaft electric current command value IMd* and the q shaft electric current command value IMq* are determined. In Step S7-4-6, the electric currents IMU and IMV are read, in Step S7-4-7, 3 phase/2 phase conversion is executed, in Step S7-4-8, the voltage command values VMd* and VMq* are calculated, in Step S7-4-9, 2 phase/3 phase conversion is executed, in Step S7-4-10, pulse-width modulation signals SU, SV, and SW are output and the process returns.

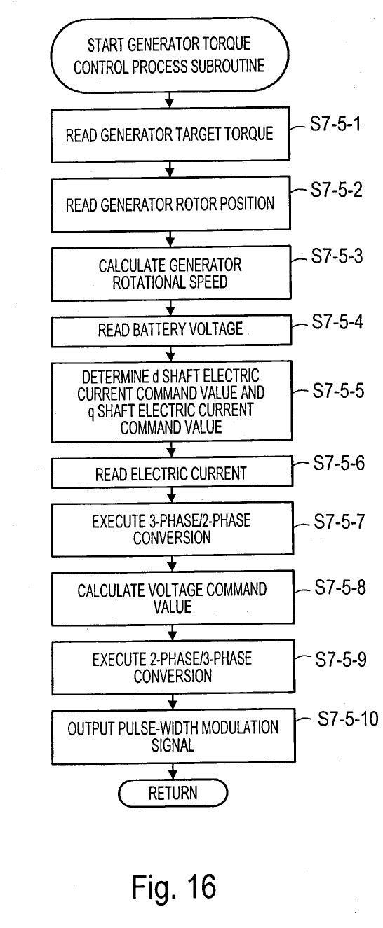

Next, a subroutine of the generator torque control process in step S7-5 of FIG. 14 will be described. FIG. 16 is a drawing illustrating the subroutine of the generator torque control process according to the first embodiment of the invention. First, the generator torque control processing mechanism reads the generator target torque TG* and then reads the generator rotor position θG to calculate the generator rotational speed NG based on the generator rotor position θG, and subsequently reads the battery voltage VB. Next, the generator torque control processing mechanism, based on the generator target torque TG*, the generator rotational speed NG, and the battery voltage VB, refers to the electric current command value map for generator control recorded in the recording equipment of the generator control device 47 (FIG. 6), and calculates and determines a d shaft electric current command value IGd* and a q shaft electric current command value IGq*. In this case, the d shaft electric current command value IGd* and the q shaft electric current command value IGq* constitute an alternating current command value for the generator 16.

Furthermore, the generator torque control processing mechanism reads the electric currents IGU and IGV from the electric current sensors 66 and 67, and calculates an electric current IGW based on the electric currents IGU and IGV:

IGW=IGU−IGV

However, the electric current IGW may also be detected by an electric current sensor, as is the case with the electric currents IGU and IGV.

Subsequently, an alternating current calculation processing mechanism (not shown) of the generator torque control processing mechanism executes an alternating current calculation process to calculate a d shaft electric current IGd and a q shaft electric current IGq by executing 3 phase/2 phase conversion and converting the electric currents IGU, IGV, and IGW into the d shaft electric current IGd and the q shaft electric current IGq. Then, an alternating voltage command value calculation processing mechanism (not shown) of the generator torque control processing mechanism executes an alternating voltage command value calculation process, and calculates voltage command values VGd* and VGq* based on the d shaft electric current IGd and the q shaft electric current IGq, as well as the d shaft electric current command value IGd* and the q shaft electric current command value IGq*. Furthermore, the generator torque control processing mechanism executes 2 phase/3 phase conversion to convert the voltage command values VGd*, VGq* into the voltage command values VGU*, VGV*, and VGW*, calculates pulse-width modulation signals SU, SV, and SW based on the voltage command values VGU*, VGV*, and VGW*, and outputs the pulse-width modulation signals SU, SV, and SW to a drive processing mechanism (not shown) of the generator control device 47. The drive processing mechanism executes the drive process, and sends the drive signal SG1 to the inverter 28 based on the pulse-width modulation signals SU, SV, and SW. In this case, the voltage command values VGd* and VGq* constitute an alternating voltage command value for the generator 16.

Next, the flow chart will be described. In Step S7-5-1, the generator target torque TG* is read, in Step S7-5-2, the generator rotor position θG is read, in Step S7-5-3, the generator rotational speed NG is calculated, in Step S7-5-4, the battery voltage VB is read, and in Step S7-5-5, the d shaft electric current command value IGd* and the q shaft electric current command value IGq* are determined. In Step S7-5-6, the electric currents IGU and IGV are read, in Step S7-5-7, 3 phase/2 phase conversion is executed, in Step S7-5-8, the voltage command values VGd* and VGq* are calculated, in Step S7-5-9, 2 phase /3 phase conversion is executed, in Step S7-5-10, pulse-width modulation signals SU, SV, and SW are output and the process returns.

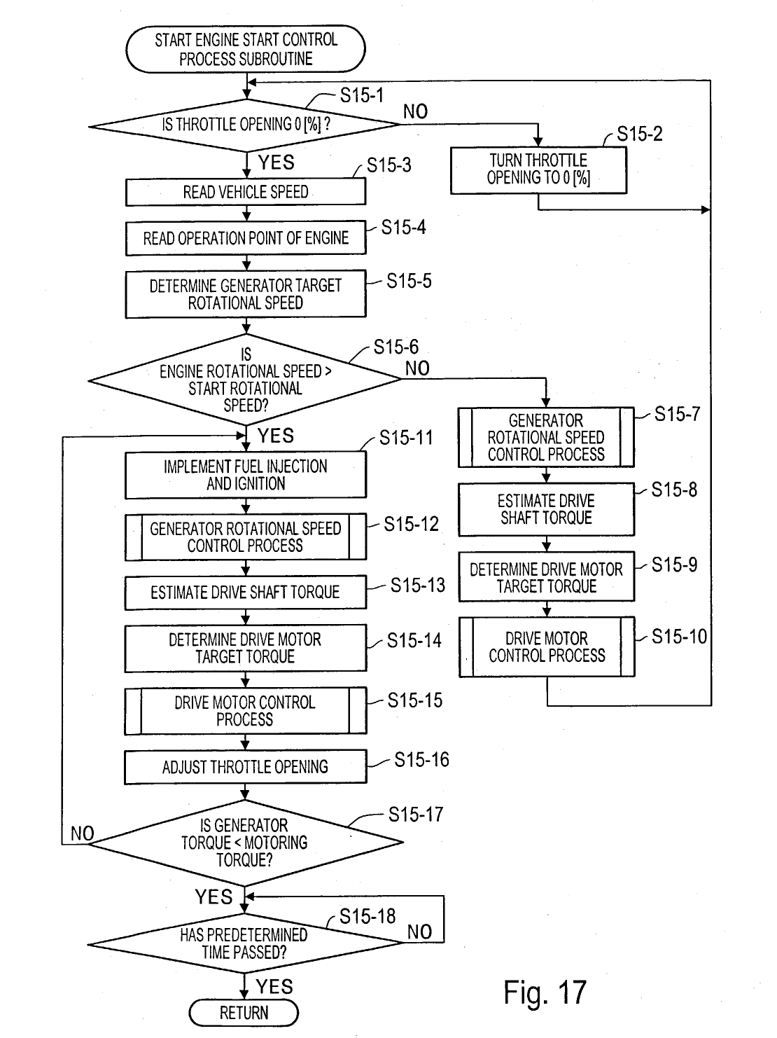

Next, a subroutine of the engine start control process in step S15 of FIG. 8 will be described. FIG. 17 is a drawing illustrating the subroutine of the engine start control process according to the first embodiment of the invention. First, the engine start control processing mechanism reads the throttle opening θ. If the throttle opening θ is 0 [%], the engine start control processing mechanism reads the vehicle speed V calculated by the vehicle speed calculation processing mechanism, and reads the operation point of the engine 11 (FIG. 6) determined in the engine target operation state setting process.

Subsequently, as described earlier, the generator target rotational speed calculation processing mechanism executes the generator target rotational speed calculation process, in which it reads the drive motor rotor position θM to calculate the ring gear rotational speed NR based on the drive motor rotor position θM and the gear ratio γR, and reads the engine target rotational speed NE* at the operation point to calculate and determine the generator target rotational speed NG* based on the ring gear rotational speed NR and the engine target rotational speed NE* using the rotational speed relational expression.

The engine control device 46 then compares the engine rotational speed NE with a preset start rotational speed NEth1, and judges whether the engine rotational speed NE is higher than the start rotational speed NEth1. If the engine rotational speed NE is higher than the start rotational speed NEth1, the engine start control processing mechanism implements fuel injection and ignition of the engine 11.

Subsequently, the generator rotational speed control processing mechanism executes the generator rotational speed control process based on the generator target rotational speed NG*, so as to increase the generator rotational speed NG and therefore increase the engine rotational speed NE.

Thereafter, as carried out in steps S25 to step S27, the drive motor control device 49 estimates the drive shaft torque TR/OUT, determines the drive motor target torque TM*, and executes the drive motor control process.

Furthermore, the engine start control processing mechanism adjusts the throttle opening θ so that the engine rotational speed NE becomes the engine target rotational speed NE*. Next, in order to judge whether the engine 11 is being driven normally, the engine start control processing mechanism judges whether the generator torque TG is less than a motoring torque TEth involved in the start of the engine 11, and waits a predetermined time period with the generator torque TG less than the motoring torque TEth.

On the other hand, if the engine rotational speed NE is equal to or lower than the start rotational speed NEth1, the generator rotational speed control processing mechanism executes the generator rotational speed control process based on the generator target rotational speed NG*. Then, as carried out in steps S25 to S27, the drive motor control device 49 estimates the drive shaft torque TR/OUT, determines the drive motor target torque TM*, and executes the drive motor control process.

Next the flow chart will be described. In Step S15-1, a determination is made whether the throttle opening θ is 0 [%]. If the throttle opening θ is 0 [%], the process proceeds to step S15-3. If not 0 [%], the process proceeds to step S15-2. In Step S15-2, the throttle opening θ is turned to 0 [%], and the process returns to step S15-1. In Step S15-3, the vehicle speed V is read, in Step S15-4, the operation point of the engine 11 is read, and in Step S15-5, the generator target rotational speed NG* is determined.

In Step S15-6, a determination is made whether the engine rotational speed NE is higher than the start rotational speed NEth1. If the engine rotational speed NE is higher than the start rotational speed NEth1, the process proceeds to step S15-11. If the engine rotational speed NE is equal to or lower than the start rotational speed NEth1, the process proceeds to step S15-7. In Step S15-7, generator rotational speed control process is executed, in Step S15-8, the drive shaft torque TR/OUT is estimated, in Step S15-9, the drive motor target torque TM* is determined, and in Step S15-10, drive motor control process is executed, and return to step 15-1 is executed.

In Step S15-11, fuel injection and ignition is implemented, in Step S15-12, generator rotational speed control process is executed, in Step S15-13, the drive shaft torque TR/OUT is estimated, in Step S15 -14, the drive motor target torque TM* is determined, in Step S15-15, drive motor control process is executed, and in Step S15-16, the throttle opening θ is adjusted.

In Step S15-17, a determination is made whether the generator torque TG is less than the motoring torque TEth. If the generator torque TG is less than the motoring torque TEth, the process proceeds to step S15-18. If the generator torque TG is equal to or greater than the motoring torque TEth, the process returns to step Si5-11. In Step S15-18, a predetermined time period elapses before the process returns.

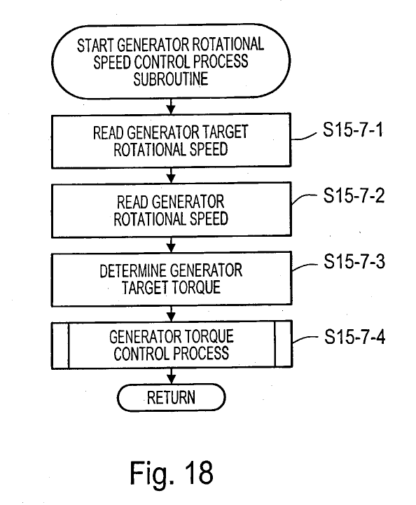

Next, a subroutine of the generator rotational speed control process in step S23 of FIG. 9 and steps S15-7 and S15-12 of FIG. 17 will be described. FIG. 18 is a drawing illustrating the subroutine of the generator rotational speed control process according to the first embodiment of the invention. First, the generator rotational speed control processing mechanism reads the generator target rotational speed NG* and the generator rotational speed NG. Then, the generator rotational speed control processing mechanism executes PI control based on a differential rotational speed ANG of the generator target rotational speed NG* and the generator rotational speed NG, and calculates and determines the generator target torque TG*. In this case, the greater the differential rotational speed ΔNG, the greater the generator target torque TG* is increased, with the positive-negative sign being considered. Subsequently, the generator torque control processing mechanism executes the generator torque control process of FIG. 16 to control the torque of the generator 16 (FIG. 6).

Next, the flow chart will be described. In this case, since the same process is executed in step S23 and steps S15-7 and S15-12, the step S15-7 will be described. In Step S15-7-1, the generator target rotational speed NG* is read, in Step S15-7-2, the generator rotational speed NG is read, in Step S15-7-3, the generator target torque TG* is calculated and determined, in Step S15-7-4, generator torque control process is executed and the process returns.

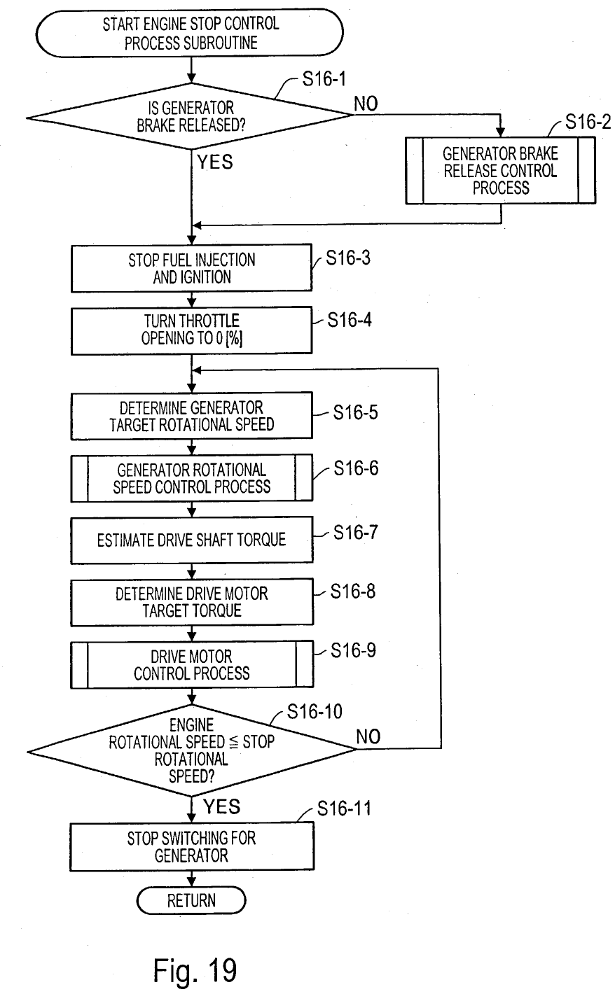

Next, a subroutine of the engine stop control process in step S16 of FIG. 8 will be described. FIG. 19 is a drawing illustrating the subroutine of the engine stop control process according to the first embodiment of the invention. First, the generator control device 47 (FIG. 6) judges whether the generator brake B is released. If the generator brake B is engaged and not released, the generator brake release control processing mechanism executes the generator brake release control process and releases the generator brake B. On the other hand, if the generator brake B is released, the engine stop control processing mechanism stops fuel injection and ignition in the engine 11, and turns the throttle opening θ to 0 [%].

Subsequently, the engine stop control processing mechanism reads the ring gear rotational speed NR and determines the generator target rotational speed NG* based on the ring gear rotational speed NR and the engine target rotational speed NE* (0 [rpm]) using the rotational speed relational expression. After the generator control device 47 executes the generator rotational speed control process in FIG. 18, as carried out in steps S25 to S27, the drive motor control device 49 estimates the drive shaft torque TR/OUT, determines the drive motor target torque TM*, and executes the drive motor control process.

Next, the generator control device 47 judges whether the engine rotational speed NE is equal to or lower than a stop rotational speed NEth2. If the engine rotational speed NE is equal to or lower than the stop rotational speed NEth2, the generator control device 47 stops the switching for the generator 16 to shut down the generator 16.

Next, the flow chart will be described. In Step S16-1, a determination is made whether the generator brake B is released. If the generator brake B is released, the process proceeds to step S16-3. If not released, the process proceeds to step S16-2. In Step S16-2, generator brake release control process is executed, Step S16-3, fuel injection and ignition are stopped, in Step S16-4, the throttle opening θ is turned to 0 [%], in Step S16-5, the generator target rotational speed NG* is determined, and in Step S16-6, generator rotational speed control process is executed. In Step S16-7, the drive shaft torque TR/OUT is estimated, in Step S16-8, the drive motor target torque TM* is determined, and in Step S16-9, drive motor control process. In Step S16-10, a determination is made whether the engine rotational speed NE is equal to or lower than the stop rotational speed NEth2. If the engine rotational speed NE is equal to or lower than the stop rotational speed NEth2, the process proceeds to step S16-11. If the engine rotational speed NE is greater than the stop rotational speed NEth2, the process returns to step S16-5. In Step S16-11, the switching for the generator 16 is stopped and the process returns.

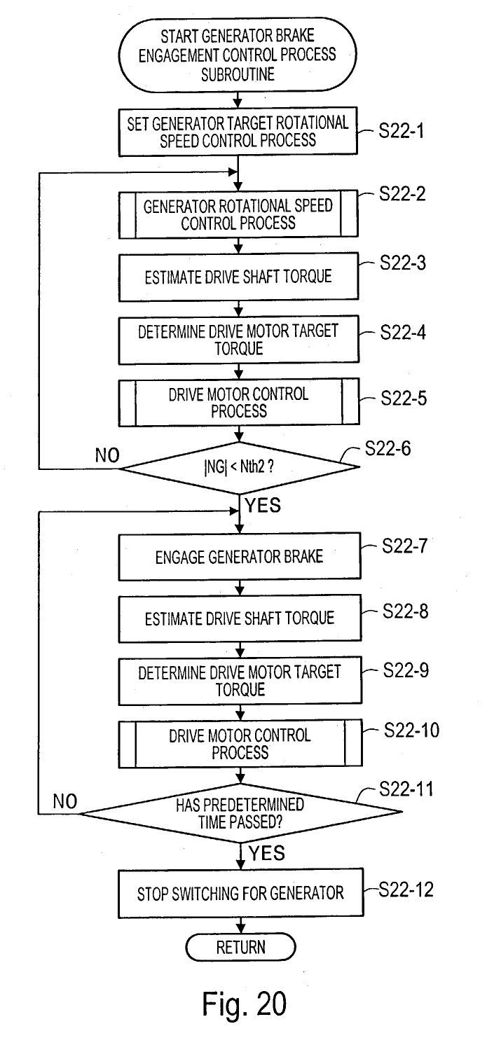

Next, a subroutine of the generator brake engage control process in step S22 of FIG. 9 will be explained. FIG. 20 is a drawing illustrating the subroutine of the generator brake engage control process according to the first embodiment of the invention. First, the generator brake engage control processing mechanism changes the generator brake requirement for requiring the engagement of the generator brake B (FIG. 6) from OFF to ON, and sets the generator target rotational speed NG* to 0 [rpm]. After the generator control device 47 executes the generator rotational speed control process in FIG. 18, as carried out in steps S25 to S27, the drive motor control device 49 estimates the drive shaft torque TR/OUT, determines the drive motor target torque TM*, and executes the drive motor control process.

Next, the generator brake engage control processing mechanism judges whether the absolute value of the generator rotational speed NG is smaller than a predetermined second rotational speed Nth2 (for example, 100 [rpm]), and engages the generator brake B if the absolute value of the generator rotational speed NG is smaller than the second rotational speed Nth2. Subsequently, as carried out in steps S25 to S27, the drive motor control device 49 estimates the drive shaft torque TR/OUT, determines the drive motor target torque TM*, and executes the drive motor control process.

Then, after a predetermined time period has passed with the generator brake B engaged, the generator brake engage control processing mechanism stops the switching for the generator 16 to shut down the generator 16.

Next, the flow chart will be described. In Step S22-1, the generator target rotational speed NG* is set to 0 [rpm], in Step S22-2, generator rotational speed control process is executed, in Step S22-3, the drive shaft torque TR/OUT is estimated, in Step S22-4, the drive motor target torque TM* is determined, and in Step S22-5, drive motor control process is executed. In Step S22-6, a determination is made whether the absolute value of the generator rotational speed NG is smaller than the second rotational speed Nth2. If the absolute value of the generator rotational speed NG is smaller than the second rotational speed Nth2, the process proceeds to step S22-7. If the absolute value of the generator rotational speed NG is equal to or greater than the second rotational speed Nth2, the process returns to step S22-2.

In Step S22-7, the generator brake B is engaged, in Step S22-8, the drive shaft torque TR/OUT is estimated, in Step S22-9, the drive motor target torque TM* is determined, and in Step S22-10, drive motor control process is executed. In Step S22-11, a determination is made whether a predetermined time period has passed. If the predetermined time period has passed, the process proceeds to step S22-12. If not, the process returns to step S22-7. In Step S22-12, the switching for the generator 16 is stopped and the process returns.

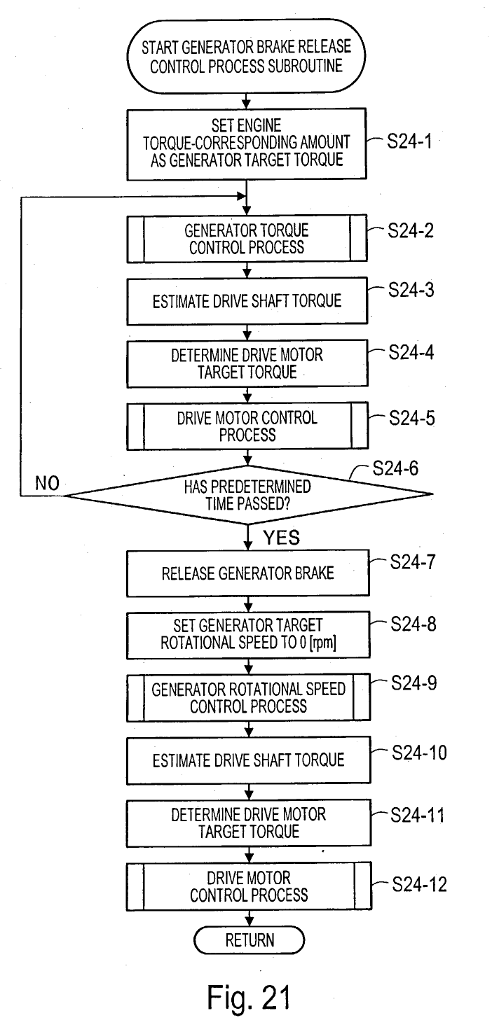

Next, a subroutine of the generator brake release control process in step S24 of FIG. 9 will be described. FIG. 21 is a drawing illustrating the subroutine of the generator brake release control process according to the first embodiment of the invention. In the generator brake engage control process, while the generator brake B (FIG. 6) is engaged, a predetermined engine torque TE is applied to the rotor 21 of the generator 16 as a reaction force. Therefore, when the generator brake B is simply released, the engine torque TE is transmitted to the rotor 21, causing a great change in the generator torque TG and the engine torque TE, thereby generating a shock.

Therefore, in the engine control device 46, the engine torque TE that is transmitted to the rotor 21 is estimated or calculated, and the generator brake release control processing mechanism reads the torque equivalent to the estimated or calculated engine torque TE, i.e. engine torque equivalent, and sets the engine torque equivalent as the generator target torque TG*. Then, after the generator torque control processing mechanism executes the generator torque control process in FIG. 16, as carried out in steps S25 to S27, the drive motor control device 49 estimates the drive shaft torque TR/OUT, determines the drive motor target torque TM*, and executes the drive motor control process.

After the generator torque control process is started, when a predetermined time period has passed, the generator brake release control processing mechanism releases the generator brake B and sets the generator target rotational speed NG* to 0 [rpm]. Then, the generator rotational speed control mechanism executes the generator rotational speed control process in FIG. 18. Subsequently, as carried out in steps S25 to S27, the drive motor control device 49 estimates the drive shaft torque TR/OUT, determines the drive motor target torque TM*, and executes the drive motor control process. In this case, the engine torque equivalent is estimated or calculated by learning the torque ratio of the generator torque TG to the engine torque TE.

Next, the flow chart will be described. In Step S24-1, the engine torque equivalent as the generator target torque TG*is set, in Step S24-2, generator torque control process is executed, in Step S24-3, the drive shaft torque TR/OUT is estimated, in Step S24-4, the drive motor target torque TM* is determined, and in Step S24-5, drive motor control process is executed. In Step S24-6, a determination is made whether a predetermined time period has passed. If the predetermined time period has passed, the process proceeds to step S24-7. If not, the process returns to step S24-2. In Step S24-7, the generator brake B is released, in Step S24-8, the generator target rotational speed NG* is set to 0 [rpm], in Step S24-9, generator rotational speed control process is executed, in Step S24-10, the drive shaft torque TR/OUT is estimated, in Step S24-11, the drive motor target torque TM* is determined, and in Step S24-12, drive motor control process is executed and the process returns.

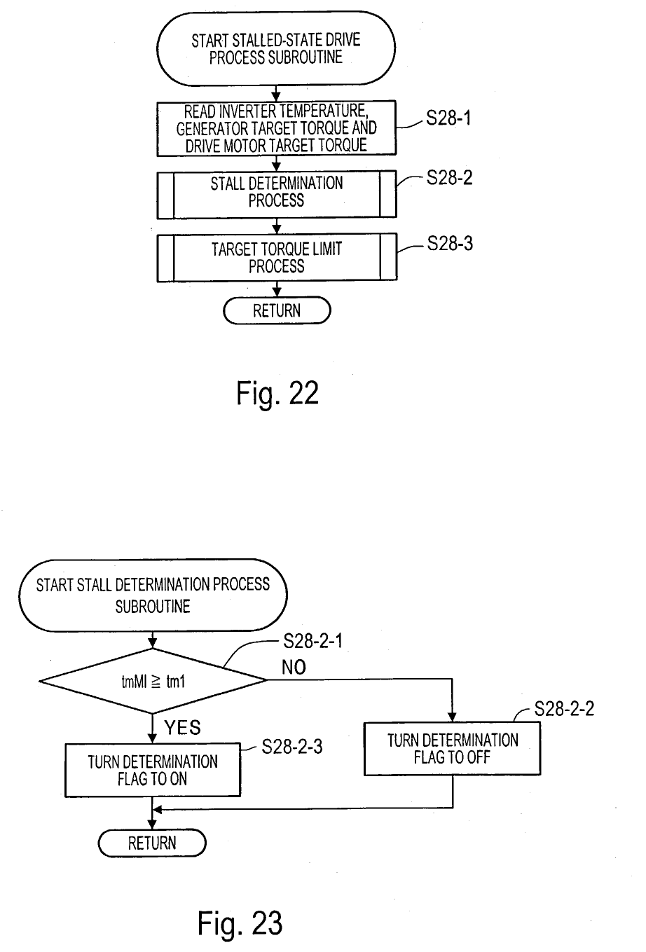

Next, a subroutine of the stalled-state drive process in step S28 of FIG. 9 will be described. FIG. 22 is a drawing illustrating the subroutine of the stalled-state drive process according to the first embodiment of the invention. The stalled-state drive processing mechanism reads the generator target torque TG*, the drive motor target torque TM*, and the second drive portion temperature which is, in the case of this embodiment, a temperature tmMI that is detected by the second inverter temperature sensor 71 (FIG. 6).

Next, a stall determination processing mechanism 91 (FIG. 1) of the stalled-state drive processing mechanism executes a stall determination process, and according to the temperature tmMI, judges whether stall determination conditions that indicate whether the hybrid vehicle is stalled have been established. If the stall determination conditions are established, a target torque control processing mechanism 92 of the stalled-state drive processing mechanism executes a target torque limit process to limit the drive motor target torque TM*, and increases and compensates the generator target torque TG* by only the amount of the drive motor target torque TM* that was limited.

A first electric machine drive processing mechanism 93 of the generator control device 47 subsequently executes a first electric machine drive process and controls the generator 16 in accordance with the compensated generator target torque TG*. Also, a second electric machine drive processing mechanism 94 of the drive motor control device 49 executes a second electric machine drive process, and controls the drive motor 25 in accordance with the limited drive motor target torque TM*. An electric machine drive processing mechanism is constituted by the first and second electric machine drive processing mechanisms 93 and 94.

In the embodiment, the drive motor target torque TM* is limited based on the temperature tmMI which is the second drive portion temperature, however in place of the temperature tmMI, it is also possible to limit the drive motor target torque TM* based on the temperatures tmM, tmMO, and the like.

Next, the flow chart will be described. In Step S28-1, the temperature tmMI of the inverter 29, the generator target torque TG*, and the drive motor target torque TM* are read, in Step S28-2, stall determination process is executed, in Step S28-3, target torque limit process is executed and the process returns.

Next, a stall determination process in step S28-2 of FIG. 22 will be described. FIG. 23 is a drawing illustrating the subroutine of the stall determination process according to the first embodiment of the invention. The stall determination processing mechanism 91 judges whether the stall determination conditions are established based on whether the temperature tmMI is equal to or higher than a threshold value tm1. If the temperature tmMI is equal to or higher than the threshold value tm1, the stall determination processing mechanism 91 judges that the stall determination conditions are established, and the hybrid vehicle is in a stalled state, thereby turning a determination flag to ON. On the other hand, if the temperature tmMI is lower than the threshold value tm1, the stall determination processing mechanism 91 judges that the stall determination conditions are not established and the hybrid vehicle is not in a stalled state, thereby turning the determination flag to OFF.

Next, the flow chart will be described. In Step S28-2-1, a determination is made whether the temperature tmMI is equal to or higher than the threshold value tm1. If the temperature tmMI is equal to or higher than the threshold value tm1, the process proceeds to step S28-2-3. If the temperature tmMI is lower than the threshold value tm1, the process proceeds to step S28-2-2. In Step 28-2-2, the determination flag is turned OFF, and in Step 28-2-3, the determination flag is turned ON. After both steps, the process returns.

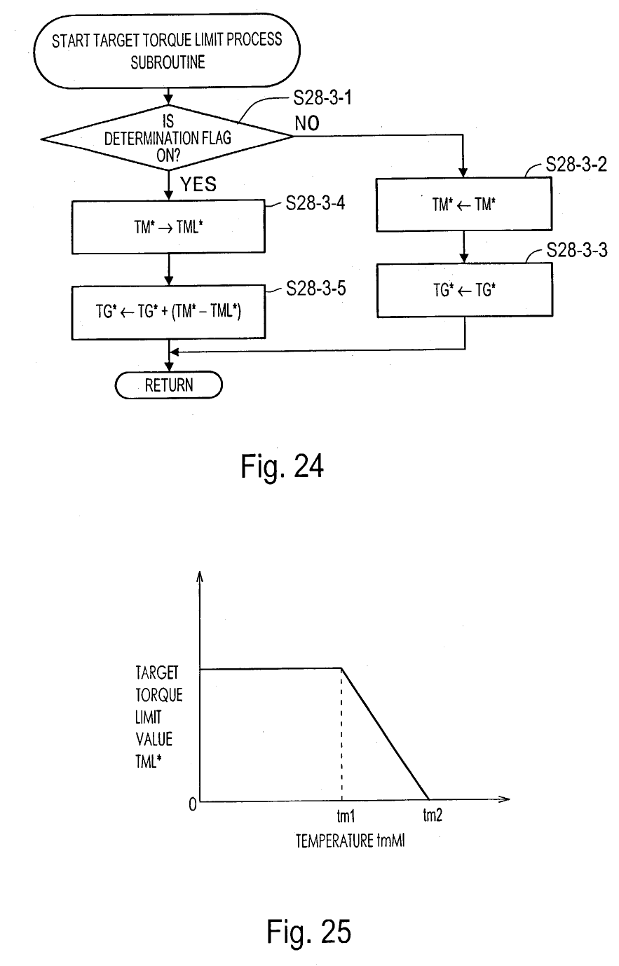

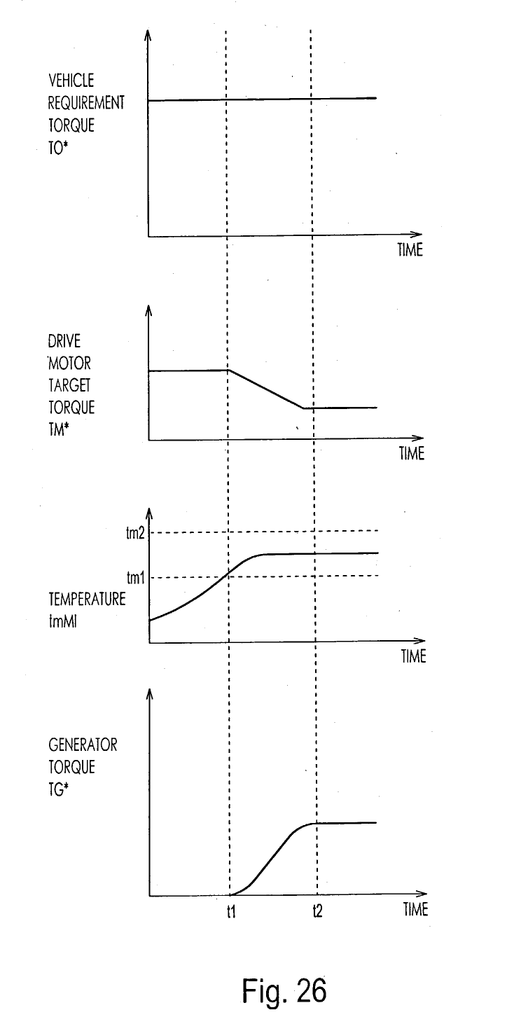

Next, a subroutine of the target torque limit process in step S28-3 of FIG. 22 will be described. FIG. 24 is a drawing illustrating the subroutine of the target torque limit process according to the first embodiment of the invention; FIG. 25 is a drawing illustrating a first target torque limit map according to the first embodiment of the invention; and FIG. 26 is a time chart illustrating a stalled-state drive process operation according to the first embodiment of the invention. In FIG. 25, the x-axis is the temperature tmMI, and the y-axis is a target torque limit value TML*.

The controller 92 (FIG. 1) judges whether the determination flag is ON. If the determination flag is ON, the controller 92 limits the drive motor target torque TM*, and if the determination flag is not ON, it does not limit the drive motor target torque TM*.

If the drive motor target torque TM* is limited, the controller 92 refers to the first target torque limit map shown in FIG. 25 that is recorded in the recording equipment of the vehicle control device 51 (FIG. 6), reads the target torque limit value TML* that indicates a limit value of the drive motor target torque TM* corresponding to the temperature tmMI, and outputs the target torque limit value TML* as the drive motor target torque TM*.

As shown in FIG. 25, the target torque limit value TML* assumes the same value as the drive motor target torque TM* when the temperature tmMI is lower than the threshold value tm1. When the temperature tmMI becomes equal to or higher than the threshold value tm1, the target torque limit value TML* decreases as the temperature tmMI increases, and when the temperature tmMI becomes a value tm2, it becomes zero (0). In the embodiment, when the temperature tmMI becomes equal to or higher than the threshold value tm1, the target torque limit value TML* decreases at a constant rate where the changing rate of the target torque limit value TML* is fixed, however the changing rate of the target torque limit value TML* may also be changed. In addition, the target torque limit value TML* may also be expressed as a function of the drive motor target torque TM* and the temperature tmMI.

The controller 92 subsequently increases the generator target torque TG* by only the amount that the drive motor target torque TM* was limited. To that end, the controller 92 subtracts the target torque limit value TML* from the drive motor target torque TM*. From that subtraction, a differential torque ΔTM* is obtained that indicates a torque equivalent to the limited drive motor target torque TM*, which is then added to the generator target torque TG* and the added value thus obtained is output as the target torque TG*.

On the other hand, if the drive motor target torque TM* is not limited, the controller 92 outputs the drive motor target torque TM* without change as the drive motor target torque TM*, and the generator target torque TG* without change as the generator target torque TG*. Thus, the generator 16 and the drive motor 25 are controlled based on the output generator target torque TG* and the drive motor target torque TM*.

Incidentally, if the wheels of the hybrid vehicle are caught in a groove or ride over a curb, thereby stalling the hybrid vehicle, the driver will attempt to escape the stalled state by pressing the accelerator pedal 54. According to this, the vehicle requirement torque TO* increases by only an amount corresponding to the increase in the accelerator pedal position AP.

As shown in FIG. 26, with the vehicle in the stalled state, the temperature tmMI of the inverter 29 increases as the drive motor 25 continues to be driven, and when it becomes the threshold value tm1 at timing t1, the drive motor target torque TM* is limited and reduced, and the generator target torque TG* is increased by that amount, thereby driving the generator 16 and the drive motor 25 and running the hybrid vehicle.

Accordingly, the hybrid vehicle can be rapidly freed from its stalled state. In connection with the hybrid vehicle being freed from its stalled state, when the temperature tmMI becomes constant at timing t2, the generator target torque TG* and the drive motor target torque TM* become a fixed value. Afterwards, when the temperature tmMI becomes lower than the threshold value tm1, the drive motor target torque TM* is no longer limited.

As described above, when the hybrid vehicle is stalled, the drive motor target torque TM* is limited and the drive motor 25 does not continue driving at a high load, therefore a large electric current does not continuously flow to a transistor module of a certain phase of the inverter 29, allowing the prevention of transistor module overheating. Accordingly, not only can the generation of abnormalities in the drive motor 25 be prevented, the life of the transistor modules is lengthened, as well as the life of the inverter 29 and the drive motor 25. In addition, a fail-safe is not implemented by the protection function of the inverter 29, resulting in no shut down of the drive motor 25 and allowing the drive motor 25 to continuously drive.

Furthermore, in connection with limiting the drive motor target torque TM*, the generator target torque TG* is compensated and increased so that both the generator 16 and the drive motor 25 is driving and the hybrid vehicle runs in a dual-motor drive state. Accordingly, the hybrid vehicle can be rapidly freed from a stalled state.

Next, the flow chart will be described. In Step S28-3-1, a determination is made whether the determination flag is ON. If the determination flag is ON, the process proceeds to step S28-3-4. If not ON (if OFF), the process proceeds to step S28-3-2. In Step S28-3-2, the calculated drive motor target torque TM* is set as the drive motor target torque TM*, in Step S28-3-3, the calculated generator target torque TG* is set as the generator target torque TG*, and the process returns. In Step S28-3-4, the target torque limit value TML* is set as the drive motor target torque TM*, in Step S28-3-5, the target torque limit value TML* is subtracted from the drive motor target torque TM*, add the differential torque ΔTM* obtained from the subtraction to the generator target torque TG*, set the added value obtained as the generator target torque TG*, and the process returns.

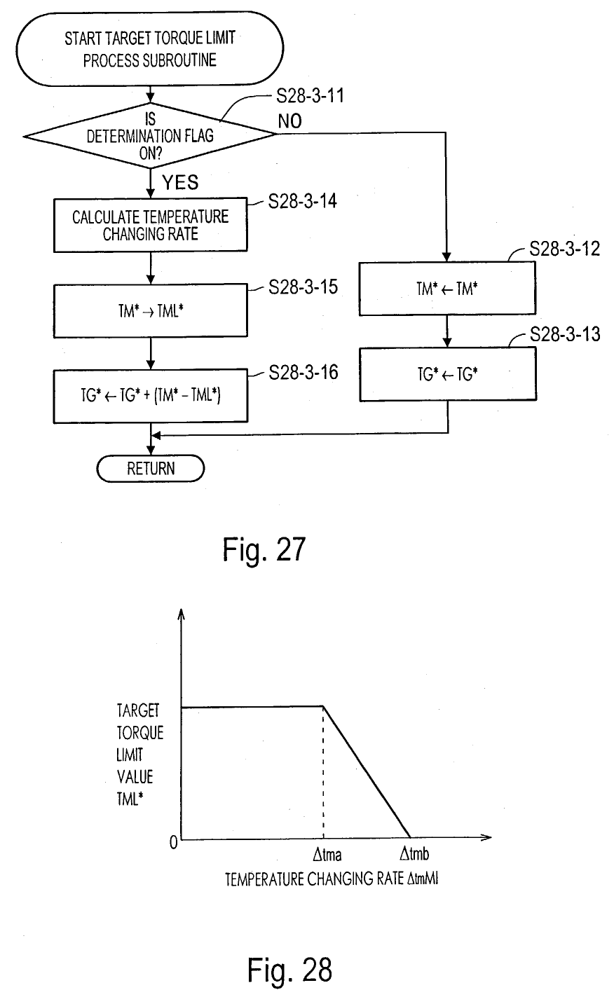

Next, a second embodiment of the invention will be described. FIG. 27 is a drawing illustrating a subroutine of a target torque limit process according to the second embodiment of the invention, and FIG. 28 is a drawing illustrating a second target torque limit map according to the second embodiment of the invention. In FIG. 28, the x-axis is the temperature changing rate ΔtmMI, and the y-axis is the target torque limit value TML*.

In this case, the controller 92 (FIG. 1) judges whether the determination flag is ON. If the determination flag is ON, the controller 92 limits the drive motor target torque TM*, and if the determination flag is not ON, it does not limit the drive motor target torque TM*.

When the drive motor target torque TM* is limited, the controller 92 calculates a temperature changing rate (temperature increase rate) ΔtmMI that indicates the increased amount of the temperature tmMI of the inverter 29 (FIG. 6) within a predetermined time period, refers to the second target torque limit map shown in FIG. 28 recorded in recording equipment (not shown) of the vehicle control device 51, reads the target torque limit value TML* corresponding to the temperature changing rate ΔtmMI, and outputs the target torque limit value TML* as the drive motor target torque TM*.

As shown in FIG. 28, when the temperature changing rate ΔtmMI is smaller than a threshold value Δtma, the target torque limit value TML* assumes the same value as the drive motor target torque TM*. On the other hand, when the temperature changing rate ΔtmMI becomes equal to or higher than the threshold value Δtma, the target torque limit value TML* decreases as the temperature changing rate ΔtmMI increases, and when the temperature changing rate ΔtmMI becomes a value Δtmb, it becomes zero (0). In the embodiment, when the temperature changing rate ΔtmMI becomes equal to or higher than the threshold value Δtma, the target torque limit value TML* decreases at a constant rate where the changing rate of the target torque limit value TML* is fixed, however the changing rate of the target torque limit value TML* may also be changed. In addition, the target torque limit value TML* may also be expressed as a function of the drive motor target torque TM* and the temperature changing rate ΔtmMI.

Next, the flow chart will be described. In Step S28-3-11, a determination is made whether the determination flag is ON. If the determination flag is ON, the process proceeds to step S28-3-14. If not ON (if OFF), the process proceeds to step S28-3-12. In Step S28-3-12, calculated drive motor target torque TM* is set as the drive motor target torque TM*, and in Step S28-3-13, the calculated generator target torque TG* is set as the generator target torque TG*, and the process returns. In Step S28-3-14, the temperature changing rate ΔtmMI is calculated, in Step S28-3-15, the target torque limit value TML* is set as the drive motor target torque TM*, in Step S28-3-16, the target torque limit value TML* is subtracted from the drive motor target torque TM*, the differential torque ΔTM* obtained from the subtraction is added to the generator target torque TG*, and the added value obtained is set as the generator target torque TG*, and the process returns.

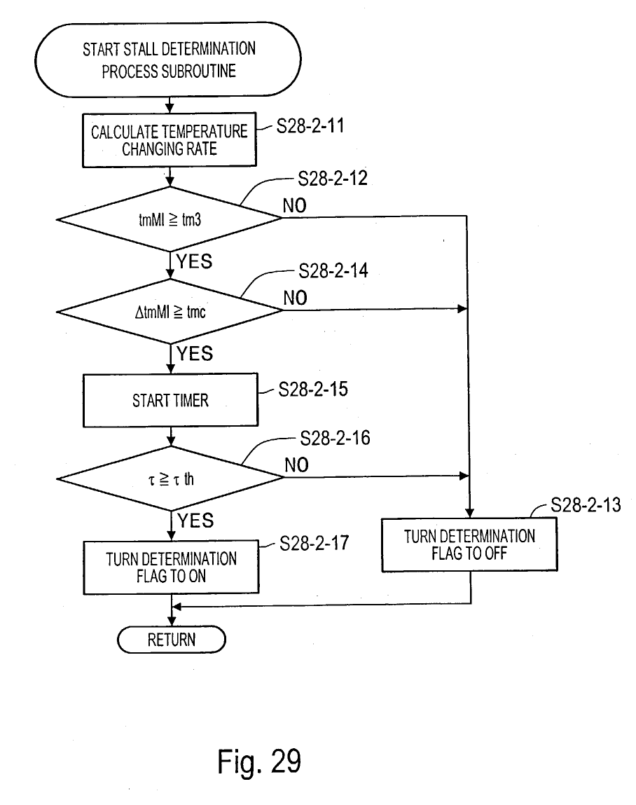

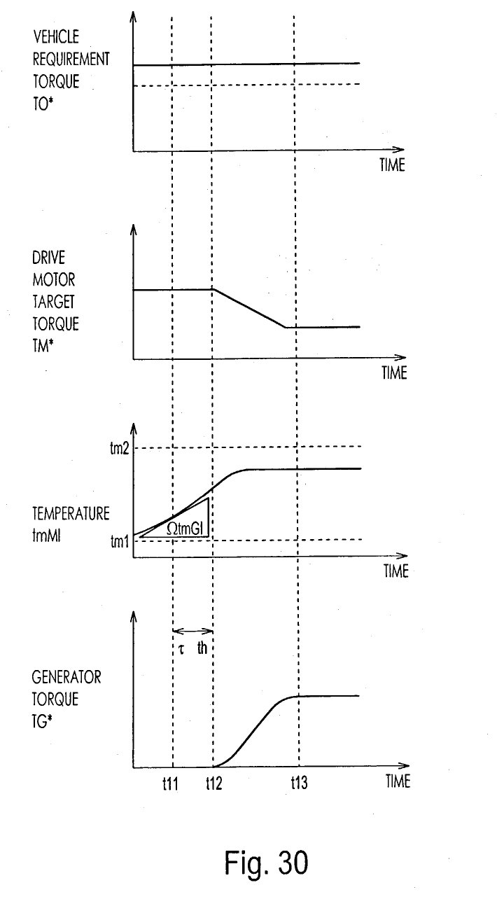

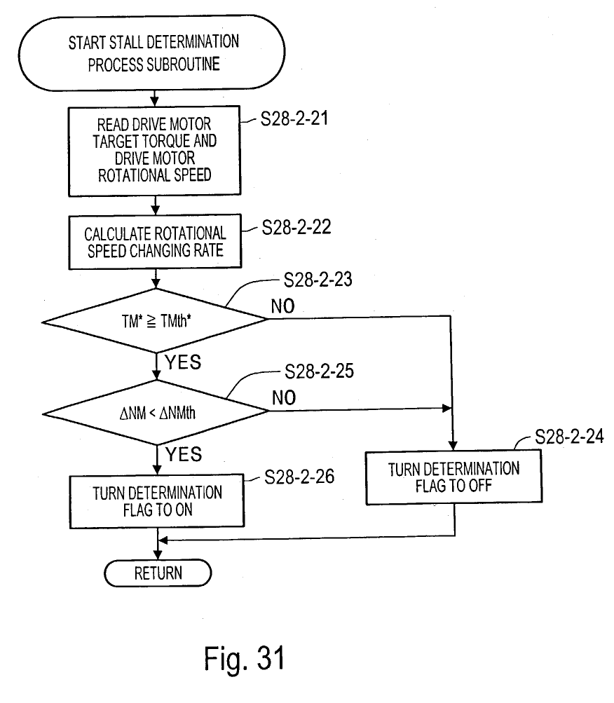

Next, a third embodiment of the invention will be described. FIG. 29 is a drawing illustrating a subroutine of a stall determination process according to the third embodiment of the invention, and FIG. 30 is a time chart illustrating a stalled-state drive process operation according to the third embodiment of the invention.

In this case, the stall determination processing mechanism 91 (FIG. 1) calculates the temperature changing rate ΔtmMI of the temperature tmMI of the inverter 29 (FIG. 6). Then, the stall determination processing mechanism 91 judges whether the stall determination conditions have been established by whether a first, second, and third conditions are established. Namely, the stall determination processing mechanism 91 judges whether the first condition is established by whether the temperature tmMI is equal to or higher than a threshold value tm3 that is lower than the threshold value tm1 in the first embodiment. The stall determination processing mechanism 91 then judges the first condition as established if the temperature tmMI is equal to or higher than the threshold value tm3, and it judges the first condition as not established if the temperature tmMI is lower than the threshold value tm3.

Furthermore, the stall determination processing mechanism 91 judges whether the second condition is established by whether the temperature changing rate ΔtmMI is equal to or higher than a threshold value tmc. The stall determination processing mechanism 91 then judges the second condition as established if the temperature changing rate ΔtmMI is equal to or higher than the threshold value tmc, and starts the time on a timer (not shown) which is built into the vehicle control device 51. The stall determination processing mechanism 91 judges the second condition as not being established if the temperature changing rate ΔtmMI is lower than the threshold value tmc.

In addition, the stall determination processing mechanism 91 judges whether the third condition is established by whether a time period τ since the timer was started is equal to or over a threshold value τth. The stall determination processing mechanism 91 then judges the third condition as established if the time period τ is equal to or over the threshold value τth, and it judges the third condition as not being established if the time period τ is shorter than the threshold value τth.

If the first, second, and third conditions are established, the stall determination processing mechanism 91 judges the stall determination conditions as established, thereby judging that the hybrid vehicle which is an electric vehicle is stalled, and turns the determination flag to ON. If the first, second, and third conditions are not established, the stall determination processing mechanism 91 judges the stall determination conditions as not established, thereby judging that the hybrid vehicle which is an electric vehicle is not stalled, and turns the determination flag to OFF.

Furthermore, in the embodiment, the controller 92 limits the drive motor target torque TM* by executing the target torque limit process according to the first and second embodiments.

Meanwhile, if the wheels of the hybrid vehicle are caught in a groove or ride over a curb, thereby stalling the hybrid vehicle, the driver will attempt to escape the stalled state by pressing the accelerator pedal 54. According to this, the vehicle requirement torque TO* increases by only an amount corresponding to the increase in the accelerator pedal position AP.

As shown in FIG. 30, with the vehicle in the stalled state, the temperature tmMI of the inverter 29 which is the second electric machine increases as the drive motor 25 continues to be driven. Then, when the temperature tmMI becomes the threshold value tm3 at a predetermined timing, and subsequently, when the temperature changing rate ΔtmMI becomes equal to or higher than the threshold value tmc at a timing t11, the time on a timer is started.

Furthermore, when the time period τ reaches the threshold value τth at a timing t12, the drive motor target torque TM* is limited and reduced, and the generator target torque TG* is increased by that amount, thereby driving the generator 16 and the drive motor 25 and running the hybrid vehicle.

Accordingly, the hybrid vehicle can be rapidly freed from its stalled state. In connection with the hybrid vehicle being freed from its stalled state, when the temperature tmMI becomes constant at a timing t13, the generator target torque TG* and the drive motor target torque TM* become a fixed value. Afterwards, when the temperature tmMI becomes lower than the threshold value tm1, the drive motor target torque TM* is no longer limited.

Next, the flow chart will be described. In Step S28-2-11, the temperature changing rate ΔtmMI is calculated. In Step S28-2-12, a determination is made whether the temperature tmMI is equal to or higher than the threshold value tm3. If the temperature tmMI is equal to or higher than the threshold value tm3, the process proceeds to step S28-2-14. If the temperature tmMI is lower than the threshold value tm3, the process proceeds to step S28-2-13. In Step S28-2-13, the determination flag is turned to OFF, and the process returns.

In Step S28-2-14, a determination is made whether the temperature changing rate ΔtmMI is equal to or higher than the threshold value tmc. If the temperature changing rate ΔtmMI is equal to or higher than the threshold value tmc, the process proceeds to step S28-2-15. If the temperature changing rate ΔtmMI is lower than the threshold value tmc, the process proceeds to step S28-2-13. In Step S28-2-15, the timer is started, and in Step S28-2-16, a determination is made whether the time period τ is equal to or over the threshold value τth. If the time period τ is equal to or over the threshhold value τth, the process step S28-2-17. If the time period τ is shorter than the threshold value τth, the process proceeds to step S28-2-13. In Step S28-2-17, the determination flag is turned to ON, and the process returns.

In the embodiment, the stall determination processing mechanism 91 is designed to judge whether the third condition is established by whether the time period τ is equal to or over the threshold value τth. However, the judgement may also be made by whether the drive motor target torque TM*, the accelerator pedal position AP, or the like are equal to or greater than a threshold value.

Also, in the embodiment, the stall determination processing mechanism 91 is designed to start the timer, when the first and second conditions are established. However, the timer may be started after the first condition is established.

Furthermore, in the first and second embodiments, the stall determination processing mechanism 91 is designed to judge whether the stall determination conditions are established by whether the temperature tmMI is equal to or higher than the threshold value tm1. However, the judgement process may be such that the timer is started when the temperature tmMI is equal to or higher than the threshold value tm1, and the stall determination conditions is judged as established when the time period is equal to or over a threshold value.

Next, a fourth embodiment of the invention will be described. FIG. 31 is a drawing illustrating a subroutine of a stall determination process according to the fourth embodiment of the invention. The stall determination processing mechanism 91 (FIG. 1) reads the drive motor target torque TM* and the drive motor rotational speed NM, and calculates a rotational speed changing rate ΔNM that indicates the amount the drive motor rotational speed NM changes within a predetermined time period. Subsequently, the stall determination processing mechanism 91 judges whether the stall determination conditions are established by whether the first and second conditions have been established. Namely, the stall determination processing mechanism 91 judges whether the first condition has been established by whether the drive motor target torque TM* is equal to or higher than a threshold value TMth*. Then, when the drive motor target torque TM* is equal to or higher than the threshold value TMth*, the stall determination processing mechanism 91 judges the first condition as established, and when the drive motor target torque TM* is smaller than the threshold value TMth*, the stall determination processing mechanism 91 judges the first condition as not established.

Furthermore, the stall determination processing mechanism 91 judges whether the second condition has been established by whether the rotational speed changing rate ΔNM is smaller than a threshold value ΔNMth. Then, when the rotational speed changing rate ΔNM is smaller than the threshold value ΔNMth, the stall determination processing mechanism 91 judges the second condition as established, and when the rotational speed changing rate ΔNM is equal to or higher than the threshold value ΔNMth, the stall determination processing mechanism 91 judges the second condition as not established.

In addition, when the first and second conditions are established, the stall determination processing mechanism 91 judges the stall determination conditions as established, thereby judging the hybrid vehicle which is an electric vehicle as stalled, and turns the determination flag to ON. When the first and second conditions are not established, the stall determination processing mechanism 91 judges the stall determination conditions as not established, thereby judging the hybrid vehicle as not stalled, and turns the determination flag to OFF.

Furthermore, in the embodiment, the controller 92 executes the target torque limit process, limiting the drive motor target torque TM* by multiplying the drive motor target torque TM* and a preset limit rate, and compensating and increasing the generator target torque TG* by only the amount that the drive motor target torque TM* is limited. The limit rate assumes a value smaller than 1, and, for example, is set in correspondence with how much the drive motor target torque TM* surpassed the threshold value TMth*, that is, the difference between the drive motor target torque TM* and the threshold value TMth*. Also, the controller 92 can limit the drive motor target torque TM* by executing the target torque limit process according to the first and second embodiments.

Next, the flow chart will be described. In Step S28-2-21, the drive motor target torque TM* and the drive motor rotational speed NM are read, in Step S28-2-22, the rotational speed changing rate ΔNM is calculated, in Step S28-2-23, a determination is made whether the drive motor target torque TM* is equal to or greater than the threshold value TMth*. If the drive motor target torque TM* is equal to or greater than the threshold value TMth*, the process proceeds to step S28-2-25. If the drive motor target torque TM* is smaller than the threshold value TMth*, the process proceeds to step S28-2-24.

In Step S28-2-24, the determination flag is turned to OFF, and the process returns. In Step S28-2-25, a determination is made whether the rotational speed changing rate ΔNM is smaller than the threshold value ΔNMth. If the rotational speed changing rate ΔNM is smaller than the threshold value ΔNMth, the process proceeds to step S28-2-26. If the rotational speed changing rate ΔNM is equal to or greater than the threshold value ΔNMth, the process proceeds to step S28-2-24. Then, in Step S28-2-26, the determination flag is turned to ON, and the process returns.

The invention is not limited to the aforementioned embodiments, and various modifications based on the purpose of the invention are possible, which are regarded as within the scope of the invention.

What is claimed is:

1. An electric vehicle drive control device, comprising:
an electric machine drive portion equipped with a first electric machine connected to a wheel of an electric vehicle and a second electric machine for running the electric vehicle; and
a controller that:
judges whether a stall determination condition which indicates whether the electric vehicle is in a stalled state is established;
limits, if the stall determination conditions is established, an electric machine target torque of the second electric machine and compensates with an electric machine target torque of the first electric machine according to an amount of the electric machine target torque of the second electric machine that was limited;
drives the first electric machine based on the compensated electric machine target torque of the first electric machine; and
drives the second electric machine based on the limited electric machine target torque of the second electric machine.

2. The electric vehicle drive control device according to claim 1, further comprising a detector that detects a drive portion temperature of the electric machine drive portion, wherein the controller judges whether the stall determination condition is established based on the drive portion temperature.

3. The electric vehicle drive control device according to claim 2, wherein the controller judges the stall determination condition as established if the drive portion temperature is equal to or greater than a first threshold value.

4. The electric vehicle drive control device according to claim 3, wherein the controller judges the stall determination condition as established if a time period, after the drive portion temperature is equal to or greater than the first threshold value, is equal to or greater than a second threshold value.

5. The electric vehicle drive control device according to claim 4, wherein the controller compensates with the electric machine target torque of the first electric machine by adding to the electric machine target torque of the first electric machine a torque substantially equivalent to the limited electric machine target torque of the second electric machine.

6. The electric vehicle drive control device according to claim 2, wherein the controller judges the stall determination condition as established if the drive portion temperature is equal to or greater than a first threshold value and a temperature changing rate of the drive portion temperature is equal to or greater than a second threshold value.

7. The electric vehicle drive control device according to claim 6, wherein the controller judges the stall determination condition as established if the drive portion temperature is equal to or greater than the first threshold value, and a time period, after the temperature changing rate of the drive portion temperature is equal to or greater than the second threshold value, is equal to or greater than a third threshold value.

8. The electric vehicle drive control device according to claim 7, wherein the controller compensates with the electric machine target torque of the first electric machine by adding to the electric machine target torque of the first electric machine a torque substantially equivalent to the limited electric machine target torque of the second electric machine.

9. The electric vehicle drive control device according to claim 2, wherein the controller compensates with the electric machine target torque of the first electric machine by adding to the electric machine target torque of the first electric machine a torque substantially equivalent to the limited electric machine target torque of the second electric machine.

10. The electric vehicle drive control device according to claim 1, further comprising a detector that detects a drive portion temperature of the electric machine drive portion, wherein the controller limits the electric machine target torque based on the drive portion temperature.

11. The electric vehicle drive control device according to claim 10, wherein the controller limits the electric machine target torque based on the temperature changing rate of the drive portion temperature.

12. The electric vehicle drive control device according claim 11, wherein the controller compensates the electric machine target torque of the first electric machine by adding to the electric machine target torque of the first electric machine a torque substantially equivalent to the limited electric machine target torque of the second electric machine.

13. The electric vehicle drive control device according to claim 10, wherein the controller compensates with the electric machine target torque of the first electric machine by adding to the electric machine target torque of the first electric machine a torque substantially equivalent to the limited electric machine target torque of the second electric machine.

14. The electric vehicle drive control device according to claim 1, further comprising a detector that detects a drive portion temperature of the electric machine drive portion, wherein the controller limits the electric machine target torque based on the temperature changing rate of the drive portion temperature.

15. The electric vehicle drive control device according to claim 14, wherein the controller compensates with the electric machine target torque of the first electric machine by adding to the electric machine target torque of the first electric machine a torque substantially equivalent to the limited electric machine target torque of the second electric machine.

16. The electric vehicle drive control device according to claim 1, wherein the controller judges the stall determination condition as established if the electric machine target torque of the second electric machine is equal to or greater than a first threshold value, and an electric machine rotational speed of the second electric machine is lower than a second threshold value.

17. The electric vehicle drive control device according to claim 16, wherein the controller compensates with the electric machine target torque of the first electric machine by adding to the electric machine target torque of the first electric machine a torque substantially equivalent to the limited electric machine target torque of the second electric machine.

18. The electric vehicle drive control device according to claim 1, wherein the controller compensates with the electric machine target torque of the first electric machine by adding to the electric machine target torque of the first electric machine a torque substantially equivalent to the limited electric machine target torque of the second electric machine.

19. The electric vehicle drive control device according to claim 1, further comprising:
an engine;
an output shaft connected to a drive wheel; and
a planetary gear unit including at least three gear elements, wherein each of the gear elements of the planetary gear is connected to the engine, the first electric machine and the output shaft, respectively and the second electric machine is connected to the output shaft.

20. An electric vehicle drive control method comprising:
judging whether a stall determination condition that indicates whether an electric vehicle is in a stalled state is established;
limiting, if the stall determination conditions is established, an electric machine target torque of a second electric machine for running the electric vehicle, and compensating with an electric machine target torque of a first electric machine connected to a wheel of the electric vehicle according to an amount of the electric machine target torque of the second electric machine that was limited;
driving the first electric machine based on the compensated electric machine target torque of the first electric machine; and
driving the second electric machine based on the limited electric machine target torque of the second electric machine.

21. The method of claim 20, further comprising detecting a drive portion temperature of an electric machine drive portion comprising the first electric machine and the second electric machine, wherein the stall determination condition is established based on the drive portion temperature.

22. The method of claim 21, wherein the electric machine target torque is limited based on the drive portion temperature.

23. The method of claim 21, wherein the electric machine target torque is limited based on the temperature changing rate of the drive portion temperature.

24. The method of claim 21, wherein electric machine target torque of the first electric machine is compensated for by adding to the electric machine target torque of the first electric machine a torque substantially equivalent to the limited electric machine target torque of the second electric machine.

25. The method of claim 20, wherein the stall determination condition is judged as established if the electric machine target torque of the second electric machine is equal to or greater than a first threshold value, and an electric machine rotational speed of the second electric machine is lower than a second threshold value.

26. The method of claim 25, wherein the electric machine target torque of the first electric machine is compensated for by adding to the electric machine target torque of the first electric machine a torque substantially equivalent to the limited electric machine target torque of the second electric machine.

27. The method of claim 20, wherein the electric machine target torque of the first electric machine is compensated for by adding to the electric machine target torque of the first electric machine a torque substantially equivalent to the limited electric machine target torque of the second electric machine.

28. The method of claim 20, wherein the electric vehicle includes an engine, an output shaft connected to a drive wheel and a planetary gear unit including at least three gear elements, further comprising:
connecting each of the gear elements of the planetary gear to the engine, the first electric machine and the output shaft, respectively; and
connecting the second electric machine to the output shaft.

29. A computer readable memory of an electric vehicle drive control device, comprising:
a program that judges whether a stall determination condition which indicates whether an electric vehicle is in a stalled state is established;
a program that, if the stall determination condition is established, limits an electric machine target torque of a second electric machine for running the electric vehicle, and compensates with an electric machine target torque of a first electric machine connected to a wheel of the electric vehicle according to an amount of the electric machine target torque of the second electric machine that was limited;
a program that drives the first electric machine based on the compensated electric machine target torque of the first electric machine; and
a program that drives the second electric machine based on the limited electric machine target torque of the second electric machine.
